(19) United States
(12) Patent Application Publication
(10) Pub. No.: US 2013/0072648 A1
(43) Pub. Date: Mar. 21, 2013

(54) SOLID CATALYST FOR OLEFIN POLYMERIZATION AND PROCESS FOR PRODUCING OLEFIN POLYMER

(71) Applicant: Sumitomo Chemical Company, Limited, Tokyo (JP)

(72) Inventors: Mitsuhiro OKADA, Ichihara-shi (JP); Wataru HIRAHATA, Ichihara-shi (JP)

(73) Assignee: SUMITOMO CHEMICAL COMPANY, LIMITED, Tokyo (JP)

(21) Appl. No.: 13/623,560

(22) Filed: Sep. 20, 2012

(30) Foreign Application Priority Data
Sep. 21, 2011 (JP) 2011-205718

(51) Int. Cl. C08F 4/649; C08F 2/00

(52) U.S. Cl. 526/126; 502/125; 502/126

(57) ABSTRACT

A solid catalyst for olefin polymerization and a process for producing an olefin polymer are provided. The polymer has a small content of a component which is dissolved out into a low temperature organic solvent, such as a low-molecular weight component and an amorphous component. The solid catalyst is obtained by bringing a solid catalyst component for olefin polymerization containing a titanium atom, a magnesium atom, a halogen atom, and an aliphatic carboxylate; an organoaluminum compound; and a compound represented by formula (I) into contact with each other:

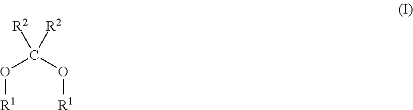

wherein R¹ is a hydrocarbyl group having 1 to 10 carbon atoms, R² is a hydrogen atom, a halogen atom or a hydrocarbyl group having 1 to 16 carbon atoms, and the R¹ the R² groups are independently the same or different, and the respective R¹ groups and R² groups may be joined with each other to form a ring.

### BACKGROUND OF THE INVENTION

1. Field of the Invention

The patent application claims the priority of the Paris Convention based on Japanese Patent Application No. 2011-205718 (filed on Sep. 21, 2011), and the entire content described in the aforementioned application is incorporated herein by reference.

The present invention relates to a solid catalyst for olefin polymerization and a process for producing an olefin polymer.

2. Description of the Related Art

Conventionally, as a catalyst component for olefin polymerization, many solid catalyst components containing a titanium atom, a magnesium atom, a halogen atom, and an internal electron donor have been proposed. Catalysts using these solid catalyst components are desired to have a high polymerization activity in polymerization of an olefin and, at the same time, to give a polymer having a small content of a component which is dissolved out into a low temperature organic solvent such as a low-molecular weight component and an amorphous component.

JP-A-2-252704 (Patent Document 1) describes polymerization of propylene in the presence of a catalyst formed of a titanium trichloride composition, an organoaluminum compound, an organosilicon compound, and a fatty acid ester compound such as adipate as an internal electron donor.

JP-A-6-49119 (Patent Document 2) discloses a catalyst for olefin polymerization, using an aliphatic carboxylate compound such as sebacate ester as an internal electron donor.

JP-A-7-126319 (Patent Document 3) and JP-A-2001-342212 (Patent Document 4) disclose a catalyst for olefin polymerization, using a catalyst component for olefin polymerization containing a titanium atom, a magnesium atom, and a halogen atom, and, as an external electron donor, a compound having an ether bond.
Patent Document 1: JP-A-2-252704
Patent Document 2: JP-A-6-49119
Patent Document 3: JP-A-7-126319
Patent Document 4: JP-A-2001-342212

### SUMMARY OF THE INVENTION

However, the above-mentioned catalysts for olefin polymerization are not satisfactory yet from the viewpoint of a content of a component which is dissolved out into a low temperature organic solvent, of the resulting olefin polymer. An object of the present invention is to provide a solid catalyst for olefin polymerization and a process for producing an olefin polymer, which give a polymer having a small content of a component which is dissolved out into a low temperature organic solvent such as a low-molecular weight component and an amorphous component.

The present invention relates to a solid catalyst for olefin polymerization obtained by bringing a solid catalyst component for olefin polymerization containing a titanium atom, a magnesium atom, a halogen atom, and an aliphatic carboxylate, an organoaluminum compound, and a compound represented by formula (I) into contact with each other:

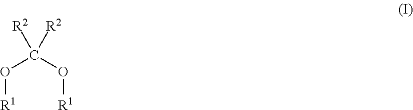

wherein R¹ is a hydrocarbyl group having 1 to 10 carbon atoms, the R¹ groups are the same or different and the R¹ groups may be joined with each other to form a ring; and R² is a hydrogen atom, a halogen atom or a hydrocarbyl group having 1 to 16 carbon atoms, the R² groups are the same or different and the R² groups may be joined with each other to form a ring.

The present invention further provides a process for producing an olefin polymer, the process comprising a step of polymerizing an olefin in the presence of the solid catalyst for olefin polymerization.

The “solid catalyst for olefin polymerization” is simply referred to as “solid catalyst” in some cases.

According to the present invention, a solid catalyst for olefin polymerization and a process for producing an olefin polymer are provided, which give a polymer having a small content of a component which is dissolved out into a low temperature organic solvent such as a low-molecular weight component and an amorphous component.

### DETAILED DESCRIPTIONS OF THE INVENTION

The compound represented by formula (I) constituting the solid catalyst for olefin polymerization of the present invention will be described:

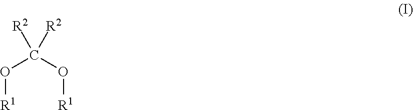

wherein R¹ is a hydrocarbyl group having 1 to 10 carbon atoms, the R¹ groups are the same or different and the R¹ groups may be joined with each other to form a ring; and R² is a hydrogen atom, a halogen atom or a hydrocarbyl group having 1 to 16 carbon atoms, the R² groups are the same or different and the R² groups may be joined with each other to form a ring.

Examples of the hydrocarbyl group of R¹ in formula (I) include an alkyl group, an aralkyl group, an aryl group, and an alkenyl group, and these may have a halogen atom, a hydrocarbyloxy group, a nitro group, a sulfonyl group, a silyl group, and the like, as a substituent.

Examples of the alkyl group of R¹ include a linear alkyl group such as a methyl group, an ethyl group, a n-propyl group, a n-butyl group, a n-pentyl group, a n-hexyl group, a n-heptyl group, and a n-octyl group; a branched alkyl group such as an isopropyl group, an isobutyl group, a tert-butyl group, an isopentyl group, a neopentyl group, and a 2-ethylhexyl group; and a cyclic alkyl group such as a cyclopropyl group, a cyclobutyl group, a cyclopentyl group, a cyclohexyl group, a cycloheptyl group, and a cyclooctyl group, and preferable is a linear, branched or cyclic alkyl group having 1 to 10 carbon atoms and more preferable is a linear or branched alkyl group having 1 to 10 carbon atoms.

Examples of the aralkyl group of R¹ include a benzyl group and a phenethyl group, and preferable is an aralkyl group having 7 to 10 carbon atoms. Examples of the aryl group of R¹ include a phenyl group, a tolyl group, and a xylyl group, and preferable is an aryl group having 6 to 10 carbon atoms. Examples of the alkenyl group of R¹ include a linear alkenyl group such as a vinyl group, an allyl group, a 3-butenyl group, and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group, and preferable is an alkenyl group having 2 to 10 carbon atoms.

R¹ in formula (I) is preferably a linear or branched alkyl group having 1 to 10 carbon atoms.

The two R¹ groups may be joined with each other. In this case, the compound of formula (I) is a cyclic ether. The cyclic ether is preferably a 4- to 8-membered ring, and more preferably a 4- to 6-membered ring.

Examples of the halogen atom of R² in formula (I) include a fluorine atom, a chlorine atom, a bromine atom or an iodine atom, and preferable is a fluorine atom, a chlorine atom or a bromine atom.

Examples of the hydrocarbyl group of R² in formula (I) include an alkyl group, an aralkyl group, an aryl group, and an alkenyl group, and these may have a halogen atom, a hydrocarbyloxy group, a nitro group, a sulfonyl group, a silyl group, and the like, as a substituent.

Examples of the alkyl group of R² include a linear alkyl group such as a methyl group, an ethyl group, a n-propyl group, a n-butyl group, a n-pentyl group, a n-hexyl group, a n-heptyl group, and a n-octyl group; a branched alkyl group such as an isopropyl group, an isobutyl group, a tert-butyl group, an isopentyl group, a neopentyl group, and a 2-ethylhexyl group; and a cyclic alkyl group such as a cyclopropyl group, a cyclobutyl group, a cyclopentyl group, a cyclohexyl group, a cycloheptyl group, and a cyclooctyl group, and preferable is a linear, branched or cyclic alkyl group having 1 to 16 carbon atoms and more preferable is a linear or branched alkyl group having 1 to 16 carbon atoms.

Examples of the aralkyl group of R² include a benzyl group and a phenethyl group, and preferable is an aralkyl group having 7 to 16 carbon atoms. Examples of the aryl group of R² include a phenyl group, a tolyl group, and a xylyl group, and preferable is an aryl group having 6 to 16 carbon atoms. Examples of the alkenyl group of R² include a linear alkenyl group such as a vinyl group, an allyl group, a 3-butenyl group, and a 5-hexenyl group; a branched alkenyl group such as an isobutenyl group and an a 5-methyl-3-pentenyl group; and a cyclic alkenyl group such as a 2-cyclohexenyl group and a 3-cyclohexenyl group, and preferable is an alkenyl group having 2 to 16 carbon atoms.

R² in formula (I) is preferably an alkyl group having 1 to 16 carbon atoms.

The two R² groups may be joined with each other to form a hydrocarbyl ring. The hydrocarbyl ring is preferably a 4- to 8-membered ring, and more preferably a 4- to 6-membered ring.

The compound represented by formula (I) is preferably a compound in which the two R² groups are both an alkyl group having 1 to 10 carbon atoms or one is a hydrogen atom and the other R² is an alkyl group having 8 to 16 carbon atoms from the viewpoint of a content of a CXS component of the resulting olefin polymer. A compound in which, of the two R² groups, one is a hydrogen atom and the other R² is an alkyl group having 10 to 14 carbon atoms is more preferable.

Examples of the compound represented by formula (I) include the following compounds: dimethoxymethane, 1,1-dimethoxyethane, 1,1-dimethoxypropane, 1,1-dimethoxybutane, 1,1-dimethoxyisobutane, 1,1-dimethoxypentane, 1,1-dimethoxyhexane, 1,1-dimethoxyheptane, 1,1-dimethoxyoctane, 1,1-dimethoxynonane, 1,1-dimethoxydecane, 1,1-dimethoxyundecane, 1,1-dimethoxydodecane, diethoxymethane, 1,1-diethoxyethane, 1,1-diethoxypropane, 1,1-diethoxybutane, 1,1-diethoxyisobutane, 1,1-diethoxypentane, 1,1-diethoxyhexane, 1,1-diethoxyheptane, 1,1-diethoxyoctane, 1,1-diethoxynonane, 1,1-diethoxydecane, 1,1-diethoxyundecane, 1,1-diethoxydodecane, di-n-propoxymethane, 1,1-di-n-propoxyethane, 1,1-di-n-propoxypropane, 1,1-di-n-propoxybutane, 1,1-di-n-propoxyisobutane, 1,1-di-n-propoxypentane, 1,1-di-n-propoxyhexane, 1,1-di-n-propoxyheptane, 1,1-di-n-propoxyoctane, 1,1-di-n-propoxynonane, 1,1-di-n-propoxydecane, 1,1-di-n-propoxyundecane, 1,1-di-n-propoxydodecane, diisopropoxymethane, 1,1-diisopropoxyethane, 1,1-diisopropoxypropane, 1,1-diisopropoxybutane, 1,1-diisopropoxyisobutane, 1,1-diisopropoxypentane, 1,1-diisopropoxyhexane, 1,1-diisopropoxyheptane, 1,1-diisopropoxyoctane, 1,1-diisopropoxynonane, 1,1-diisopropoxydecane, 1,1-diisopropoxyundecane, 1,1-diisopropoxydodecane, di-n-butoxymethane, 1,1-di-n-butoxyethane, 1,1-di-n-butoxypropane, 1,1-di-n-butoxybutane, 1,1-di-n-butoxyisobutane, 1,1-di-n-butoxypentane, 1,1-di-n-butoxyhexane, 1,1-di-n-butoxyheptane, 1,1-di-n-butoxyoctane, 1,1-di-n-butoxynonane, 1,1-di-n-butoxydecane, 1,1-di-n-butoxyundecane, 1,1-di-n-butoxydodecane, diisobutoxymethane, 1,1-diisobutoxyethane, 1,1-diisobutoxypropane, 1,1-diisobutoxybutane, 1,1-diisobutoxyisobutane, 1,1-diisobutoxypentane, 1,1-diisobutoxyhexane, 1,1-diisobutoxyheptane, 1,1-diisobutoxyoctane, 1,1-diisobutoxynonane, 1,1-diisobutoxydecane, 1,1-diisobutoxyundecane, 1,1-diisobutoxydodecane, 2,2-dimethoxypropane, 2,2-dimethoxybutane, 2,2-dimethoxypentane, 2,2-dimethoxyhexane, 2,2-dimethoxyheptane, 2,2-dimethoxyoctane, 2,2-dimethoxynonane, 2,2-dimethoxydecane, 2,2-dimethoxyundecane, 2,2-dimethoxydodecane, 2,2-diethoxypropane, 2,2-diethoxybutane, 2,2-diethoxypentane, 2,2-diethoxyhexane, 2,2-diethoxyheptane, 2,2-diethoxyoctane, 2,2-diethoxynonane, 2,2-diethoxydecane, 2,2-diethoxyundecane, 2,2-diethoxydodecane, 2,2-di-n-propoxypropane, 2,2-di-n-propoxybutane, 2,2-di-n-propoxypentane, 2,2-di-n-propoxyhexane, 2,2-di-n-propoxyheptane, 2,2-di-n-propoxyoctane, 2,2-di-n-propoxynonane, 2,2-di-n-propoxydecane, 2,2-di-n-propoxyundecane, 2,2-di-n-propoxydodecane, 2,2-diisopropoxypropane, 2,2-diisopropoxybutane, 2,2-diisopropoxypentane, 2,2-diisopropoxyhexane, 2,2-diisopropoxyheptane, 2,2-diisopropoxyoctane, 2,2-diisopropoxynonane, 2,2-diisopropoxydecane, 2,2-diisopropoxyundecane, 2,2-diisopropoxydodecane, 2,2-di-n-butoxypropane, 2,2-di-n-butoxybutane, 2,2-di-n-butoxypentane, 2,2-di-n-butoxyhexane, 2,2-di-n-butoxyheptane, 2,2-di-n-butoxyoctane, 2,2-di-n-butoxynonane, 2,2-di-n-butoxydecane, 2,2-di-n-butoxyundecane, 2,2-di-n-butoxydodecane, 2,2-diisobutoxypropane, 2,2-diisobutoxybutane, 2,2-diisobutoxypentane, 2,2-diisobutoxyhexane, 2,2-diisobutoxyheptane, 2,2-diisobutoxyoctane, 2,2-diisobutoxynonane, 2,2-diisobutoxydecane, 2,2-diisobutoxyundecane, 2,2-diisobutoxydodecane, 3,3-dimethoxypentane, 3,3-dimethoxyhexane, 3,3-dimethoxyheptane, 3,3-dimethoxyoctane, 3,3-dimethoxynonane, 3,3-dimethoxydecane, 3,3-dimethoxyundecane, 3,3-dimethoxydodecane, 3,3-diethoxypentane, 3,3-diethoxyhexane, 3,3-diethoxyheptane, 3,3-diethoxyoctane, 3,3-diethoxynonane, 3,3-diethoxydecane, 3,3-diethoxyundecane, 3,3-diethoxydodecane, 3,3-di-n-propoxypentane, 3,3-di-n-propoxyhexane, 3,3-di-n-propoxyheptane, 3,3-di-n-propoxyoctane, 3,3-di-n-propoxynonane, 3,3-di-n-propoxydecane, 3,3-di-n-propoxyundecane, 3,3-di-n-propoxydodecane, 3,3-diisopropoxypentane, 3,3-diisopropoxyhexane, 3,3-diisopropoxyheptane, 3,3-diisopropoxyoctane, 3,3-diisopropoxynonane, 3,3-diisopropoxydecane, 3,3-diisopropoxyundecane, 3,3-diisopropoxydodecane, 3,3-di-n-butoxypentane, 3,3-di-n-butoxyhexane, 3,3-di-n-butoxyheptane, 3,3-di-n-butoxyoctane, 3,3-di-n-butoxynonane, 3,3-di-n-butoxydecane, 3,3-di-n-butoxyundecane, 3,3-di-n-butoxydodecane, 3,3-diisobutoxypentane, 3,3-diisobutoxyhexane, 3,3-diisobutoxyheptane, 3,3-diisobutoxyoctane, 3,3-diisobutoxynonane, 3,3-diisobutoxydecane, 3,3-diisobutoxyundecane, 3,3-diisobutoxydodecane, 4,4-dimethoxyheptane, 4,4-dimethoxyoctane, 4,4-dimethoxynonane, 4,4-dimethoxydecane, 4,4-dimethoxyundecane, 4,4-dimethoxydodecane, 4,4-diethoxyheptane, 4,4-diethoxyoctane, 4,4-diethoxynonane, 4,4-diethoxydecane, 4,4-diethoxyundecane, 4,4-diethoxydodecane, 4,4-di-n-propoxyheptane, 4,4-di-n-propoxyoctane, 4,4-di-n-propoxynonane, 4,4-di-n-propoxydecane, 4,4-di-n-propoxyundecane, 4,4-di-n-propoxydodecane, 4,4-diisopropoxyheptane, 4,4-diisopropoxyoctane, 4,4-diisopropoxynonane, 4,4-diisopropoxydecane, 4,4-diisopropoxyundecane, 4,4-diisopropoxydodecane, 4,4-di-n-butoxyheptane, 4,4-di-n-butoxyoctane, 4,4-di-n-butoxynonane, 4,4-di-n-butoxydecane, 4,4-di-n-butoxyundecane, 4,4-di-n-butoxydodecane, 4,4-diisobutoxyheptane, 4,4-diisobutoxyoctane, 4,4-diisobutoxynonane, 4,4-diisobutoxydecane, 4,4-diisobutoxyundecane, 4,4-diisobutoxydodecane, 5,5-dimethoxynonane, 5,5-dimethoxydecane, 5,5-dimethoxyundecane, 5,5-dimethoxydodecane, 5,5-diethoxynonane, 5,5-diethoxydecane, 5,5-diethoxyundecane, 5,5-diethoxydodecane, 5,5-di-n-propoxynonane, 5,5-di-n-propoxydecane, 5,5-di-n-propoxyundecane, 5,5-di-n-propoxydodecane, 5,5-diisopropoxynonane, 5,5-diisopropoxydecane, 5,5-diisopropoxyundecane, 5,5-diisopropoxydodecane, 5,5-di-n-butoxynonane, 5,5-di-n-butoxydecane, 5,5-di-n-butoxyundecane, 5,5-di-n-butoxydodecane, 5,5-diisobutoxynonane, 5,5-diisobutoxydecane, 5,5-diisobutoxyundecane, 5,5-diisobutoxydodecane, 6,6-dimethoxyundecane, 6,6-dimethoxydodecane, 6,6-diethoxyundecane, 6,6-diethoxydodecane, 6,6-di-n-propoxyundecane, 6,6-di-n-propoxydodecane, 6,6-diisopropoxyundecane, 6,6-diisopropoxydodecane, 6,6-di-n-butoxyundecane, 6,6-di-n-butoxydodecane, 6,6-diisobutoxyundecane, 6,6-diisobutoxydodecane, 3-(dimethoxymethyl)heptane, 1,1-dimethoxycyclopentane, 1,1-dimethoxycyclohexane, 3,3-dimethoxy-1-cyclohexene, 1,1-dimethoxycycloheptane, 1,1-dimethoxycyclooctane, 1,1-dimethoxycyclononane, 1,1-dimethoxycyclodecane, 1,1-dimethoxycycloundecane, 1,1-dimethoxycyclododecane, 1,1-diethoxycyclopentane, 1,1-diethoxycyclohexane, 3,3-diethoxy-1-cyclohexene, 1,1-diethoxycycloheptane, 1,1-diethoxycyclooctane, 1,1-diethoxycyclononane, 1,1-diethoxycyclodecane, 1,1-diethoxycycloundecane, 1,1-diethoxycyclododecane, 1,1-di-n-propoxycyclopentane, 1,1-di-n-propoxycyclohexane, 1,1-di-n-propoxycycloheptane, 1,1-di-n-propoxycyclooctane, 1,1-di-n-propoxycyclononane, 1,1-di-n-propoxycyclodecane, 1,1-di-n-propoxycycloundecane, 1,1-di-n-propoxycyclododecane, 1,1-diisopropoxycyclopentane, 1,1-diisopropoxycyclohexane, 1,1-diisopropoxycycloheptane, 1,1-diisopropoxycyclooctane, 1,1-diisopropoxycyclononane, 1,1-diisopropoxycyclodecane, 1,1-diisopropoxycycloundecane, 1,1-diisopropoxycyclododecane, 1,1-di-n-butoxycyclopentane, 1,1-di-n-butoxycyclohexane, 1,1-di-n-butoxycycloheptane, 1,1-di-n-butoxycyclooctane, 1,1-di-n-butoxycyclononane, 1,1-di-n-butoxycyclodecane, 1,1-di-n-butoxycycloundecane, 1,1-di-n-butoxycyclododecane, 1,1-diisobutoxycyclopentane, 1,1-diisobutoxycyclohexane, 1,1-diisobutoxycycloheptane, 1,1-diisobutoxycyclooctane, 1,1-diisobutoxycyclononane, 1,1-diisobutoxycyclodecane, 1,1-diisobutoxycycloundecane, 1,1-diisobutoxycyclododecane, 1,3-dioxolane, 2-methyl-1,3-dioxolane, 2-ethyl-1,3-dioxolane, 2-n-propyl-1,3-dioxolane, 2-isopropyl-1,3-dioxolane, 2-n-butyl-1,3-dioxolane, 2-isobutyl-1,3-dioxolane, 2-pentyl-1,3-dioxolane, 2-hexyl-1,3-dioxolane, 2-heptyl-1,3-dioxolane, 2-octyl-1,3-dioxolane, 2-decyl-1,3-dioxolane, 2-dodecyl-1,3-dioxolane, 2-phenyl-1,3-dioxolane, 2-benzyl-1,3-dioxolane, 2,2-dimethyl-1,3-dioxolane, 2-methyl-2-ethyl-1,3-dioxolane, 2-n-propyl-2-methyl-1,3-dioxolane, 2-isopropyl-2-methyl-1,3-dioxolane, 2-n-butyl-2-methyl-1,3-dioxolane, 2-isobutyl-2-methyl-1,3-dioxolane, 2-methyl-2-pentyl-1,3-dioxolane, 2-hexyl-2-methyl-1,3-dioxolane, 2-heptyl-2-methyl-1,3-dioxolane, 2-octyl-2-methyl-1,3-dioxolane, 2-decyl-2-methyl-1,3-dioxolane, 2-dodecyl-2-methyl-1,3-dioxolane, 2-phenyl-2-methyl-1,3-dioxolane, 2-benzyl-2-methyl-1,3-dioxolane, 2,2-diethyl-1,3-dioxolane, 2-ethyl-2-n-propyl-1,3-dioxolane, 2-ethyl-2-isopropyl-1,3-dioxolane, 2-ethyl-2-n-butyl-1,3-dioxolane, 2-ethyl-2-isobutyl-1,3-dioxolane, 2-ethyl-2-pentyl-1,3-dioxolane, 2-ethyl-2-hexyl-1,3-dioxolane, 2-ethyl-2-heptyl-1,3-dioxolane, 2-ethyl-2-octyl-1,3-dioxolane, 2-ethyl-2-decyl-1,3-dioxolane, 2-ethyl-2-dodecyl-1,3-dioxolane, 2-ethyl-2-phenyl-1,3-dioxolane, 2-benzyl-2-ethyl-1,3-dioxolane, 2,2-di-n-propyl-1,3-dioxolane, 2-isopropyl-2-n-propyl-1,3-dioxolane, 2-n-propyl-2-n-butyl-1,3-dioxolane, 2-isobutyl-2-n-propyl-1,3-dioxolane, 2-pentyl-2-n-propyl-1,3-dioxolane, 2-hexyl-2-n-propyl-1,3-dioxolane, 2-heptyl-2-n-propyl-1,3-dioxolane, 2-octyl-2-n-propyl-1,3-dioxolane, 2-decyl-2-n-propyl-1,3-dioxolane, 2-dodecyl-2-n-propyl-1,3-dioxolane, 2-phenyl-2-n-propyl-1,3-dioxolane, 2-benzyl-2-n-propyl-1,3-dioxolane, 2,2-diisopropyl-1,3-dioxolane, 2-isopropyl-2-n-butyl-1,3-dioxolane, 2-isobutyl-2-isopropyl-1,3-dioxolane, 2-isopropyl-2-pentyl-1,3-dioxolane, 2-hexyl-2-isopropyl-1,3-dioxolane, 2-heptyl-2-isopropyl-1,3-dioxolane, 2-isopropyl-2-octyl-1,3-dioxolane, 2-decyl-2-isopropyl-1,3-dioxolane, 2-dodecyl-2-isopropyl-1,3-dioxolane, 2-isopropyl-2-phenyl-1,3-dioxolane, 2-benzyl-2-isopropyl-1,3-dioxolane, 2,2-di-n-butyl-1,3-dioxolane, 2-isobutyl-2-n-butyl-1,3-dioxolane, 2-n-butyl-2-pentyl-1,3-dioxolane, 2-n-butyl-2-hexyl-1,3-dioxolane, 2-n-butyl-2-heptyl-1,3-dioxolane, 2-n-butyl-2-octyl-1,3-dioxolane, 2-n-butyl-2-decyl-1,3-dioxolane, 2-n-butyl-2-dodecyl-1,3-dioxolane, 2-n-butyl-2-phenyl-1,3-dioxolane, 2-benzyl-2-n-butyl-1,3-dioxolane, 2,2-diisobutyl-1,3-dioxolane, 2-isobutyl-2-pentyl-1,3-dioxolane, 2-hexyl-2-isobutyl-1,3-dioxolane, 2-heptyl-2-isobutyl-1,3-dioxolane, 2-isobutyl-2-octyl-1,3-dioxolane, 2-decyl-2-isobutyl-1,3-dioxolane, 2-dodecyl-2-isobutyl-1,3-dioxolane, 2-isobutyl-2-phenyl-1,3-dioxolane, 2-benzyl-2-isobutyl-1,3-dioxolane, 2,2-dipentyl-1,3-dioxolane, 2-hexyl-2-pentyl-1,3-dioxolane, 2-heptyl-2-pentyl-1,3-dioxolane, 2-octyl-2-pentyl-1,3-dioxolane, 2-decyl-2-pentyl-1,3-dioxolane, 2-dodecyl-2-pentyl-1,3-dioxolane, 2-pentyl-2-phenyl-1,3-dioxolane, 2-benzyl-2-pentyl-1,3-dioxolane, 2,2-dihexyl-1,3-dioxolane, 2-hexyl-2-heptyl-1,3-dioxolane, 2-hexyl-2-octyl-1,3-dioxolane, 2-decyl-2-hexyl-1,3-dioxolane, 2-dodecyl-2-hexyl-1,3-dioxolane, 2-hexyl-2-phenyl-1,3-dioxolane, 2-benzyl-2-hexyl-1,3-dioxolane, 2,2-diheptyl-1,3-dioxolane, 2-heptyl-2-octyl-1,3-dioxolane, 2-decyl-2-heptyl-1,3-dioxolane, 2-dodecyl-2-heptyl-1,3-dioxolane, 2-heptyl-2-phenyl-1,3-dioxolane, 2-benzyl-2-heptyl-1,3-dioxolane, 2,2-dioctyl-1,3-dioxolane, 2-decyl-2-octyl-1,3-dioxolane, 2-dodecyl-2-octyl-1,3-dioxolane, 2-octyl-2-phenyl-1,3-dioxolane, 2-benzyl-2-octyl-1,3-dioxolane, 2,2-didecyl-1,3-dioxolane, 2-decyl-2-dodecyl-1,3-dioxolane, 2-decyl-2-phenyl-1,3-dioxolane, 2-benzyl-2-decyl-1,3-dioxolane, 2,2-didodecyl-1,3-dioxolane, 2-dodecyl-2-phenyl-1,3-dioxolane, 2-benzyl-2-dodecyl-1,3-dioxolane, 2,2-diphenyl-1,3-dioxolane, 2-benzyl-2-phenyl-1,3-dioxolane, 2,2-dibenzyl-1,3-dioxolane, 1,3-dioxane, 2-methyl-1,3-dioxane, 2-ethyl-1,3-dioxane, 2-n-propyl-1,3-dioxane, 2-isopropyl-1,3-dioxane, 2-n-butyl-1,3-dioxane, 2-isobutyl-1,3-dioxane, 2-pentyl-1,3-dioxane, 2-hexyl-1,3-dioxane, 2-heptyl-1,3-dioxane, 2-octyl-1,3-dioxane, 2-decyl-1,3-dioxane, 2-dodecyl-1,3-dioxane, 2-phenyl-1,3-dioxane, 2-benzyl-1,3-dioxane, 2,2-dimethyl-1,3-dioxane, 2-ethyl-2-methyl-1,3-dioxane, 2-n-propyl-2-methyl-1,3-dioxane, 2-isopropyl-2-methyl-1,3-dioxane, 2-n-butyl-2-methyl-1,3-dioxane, 2-isobutyl-2-methyl-1,3-dioxane, 2-methyl-2-pentyl-1,3-dioxane, 2-hexyl-2-methyl-1,3-dioxane, 2-heptyl-2-methyl-1,3-dioxane, 2-octyl-2-methyl-1,3-dioxane, 2-decyl-2-methyl-1,3-dioxane, 2-dodecyl-2-methyl-1,3-dioxane, 2-phenyl-2-methyl-1,3-dioxane, 2-benzyl-2-methyl-1,3-dioxane, 2,2-diethyl-1,3-dioxane, 2-ethyl-2-n-propyl-1,3-dioxane, 2-ethyl-2-isopropyl-1,3-dioxane, 2-ethyl-2-n-butyl-1,3-dioxane, 2-ethyl-2-isobutyl-1,3-dioxane, 2-ethyl-2-pentyl-1,3-dioxane, 2-ethyl-2-hexyl-1,3-dioxane, 2-ethyl-2-heptyl-1,3-dioxane, 2-ethyl-2-octyl-1,3-dioxane, 2-ethyl-2-decyl-1,3-dioxane, 2-ethyl-2-dodecyl-1,3-dioxane, 2-ethyl-2-phenyl-1,3-dioxane, 2-benzyl-2-ethyl-1,3-dioxane, 2,2-di-n-propyl-1,3-dioxane, 2-isopropyl-2-n-propyl-1,3-dioxane, 2-n-propyl-2-n-butyl-1,3-dioxane, 2-isobutyl-2-n-propyl-1,3-dioxane, 2-pentyl-2-n-propyl-1,3-dioxane, 2-hexyl-2-n-propyl-1,3-dioxane, 2-heptyl-2-n-propyl-1,3-dioxane, 2-octyl-2-n-propyl-1,3-dioxane, 2-decyl-2-n-propyl-1,3-dioxane, 2-dodecyl-2-n-propyl-1,3-dioxane, 2-phenyl-2-n-propyl-1,3-dioxane, 2-benzyl-2-n-propyl-1,3-dioxane, 2,2-diisopropyl-1,3-dioxane, 2-isopropyl-2-n-butyl-1,3-dioxane, 2-isobutyl-2-isopropyl-1,3-dioxane, 2-isopropyl-2-pentyl-1,3-dioxane, 2-hexyl-2-isopropyl-1,3-dioxane, 2-heptyl-2-isopropyl-1,3-dioxane, 2-isopropyl-2-octyl-1,3-dioxane, 2-decyl-2-isopropyl-1,3-dioxane, 2-dodecyl-2-isopropyl-1,3-dioxane, 2-isopropyl-2-phenyl-1,3-dioxane, 2-benzyl-2-isopropyl-1,3-dioxane, 2,2-di-n-butyl-1,3-dioxane, 2-isobutyl-2-n-butyl-1,3-dioxane, 2-n-butyl-2-pentyl-1,3-dioxane, 2-n-butyl-2-hexyl-1,3-dioxane, 2-n-butyl-2-heptyl-1,3-dioxane, 2-n-butyl-2-octyl-1,3-dioxane, 2-n-butyl-2-decyl-1,3-dioxane, 2-n-butyl-2-dodecyl-1,3-dioxane, 2-n-butyl-2-phenyl-1,3-dioxane, 2-benzyl-2-n-butyl-1,3-dioxane, 2,2-diisobutyl-1,3-dioxane, 2-isobutyl-2-pentyl-1,3-dioxane, 2-hexyl-2-isobutyl-1,3-dioxane, 2-heptyl-2-isobutyl-1,3-dioxane, 2-isobutyl-2-octyl-1,3-dioxane, 2-decyl-2-isobutyl-1,3-dioxane, 2-dodecyl-2-isobutyl-1,3-dioxane, 2-isobutyl-2-phenyl-1,3-dioxane, 2-benzyl-2-isobutyl-1,3-dioxane, 2,2-dipentyl-1,3-dioxane, 2-hexyl-2-pentyl-1,3-dioxane, 2-heptyl-2-pentyl-1,3-dioxane, 2-octyl-2-pentyl-1,3-dioxane, 2-decyl-2-pentyl-1,3-dioxane, 2-dodecyl-2-pentyl-1,3-dioxane, 2-pentyl-2-phenyl-1,3-dioxane, 2-benzyl-2-pentyl-1,3-dioxane, 2,2-dihexyl-1,3-dioxane, 2-hexyl-2-heptyl-1,3-dioxane, 2-hexyl-2-octyl-1,3-dioxane, 2-decyl-2-hexyl-1,3-dioxane, 2-dodecyl-2-hexyl-1,3-dioxane, 2-hexyl-2-phenyl-1,3-dioxane, 2-benzyl-2-hexyl-1,3-dioxane, 2,2-diheptyl-1,3-dioxane, 2-heptyl-2-octyl-1,3-dioxane, 2-decyl-2-heptyl-1,3-dioxane, 2-dodecyl-2-heptyl-1,3-dioxane, 2-heptyl-2-phenyl-1,3-dioxane, 2-benzyl-2-heptyl-1,3-dioxane, 2,2-dioctyl-1,3-dioxane, 2-decyl-2-octyl-1,3-dioxane, 2-dodecyl-2-octyl-1,3-dioxane, 2-octyl-2-phenyl-1,3-dioxane, 2-benzyl-2-octyl-1,3-dioxane, 2,2-didecyl-1,3-dioxane, 2-decyl-2-dodecyl-1,3-dioxane, 2-decyl-2-phenyl-1,3-dioxane, 2-benzyl-2-decyl-1,3-dioxane, 2,2-didodecyl-1,3-dioxane, 2-dodecyl-2-phenyl-1,3-dioxane, 2-benzyl-2-dodecyl-1,3-dioxane, 2,2-diphenyl-1,3-dioxane, 2-benzyl-2-phenyl-1,3-dioxane, 2,2-dibenzyl-1,3-dioxane, 1,3-dioxepane, 2-methyl-1,3-dioxepane, 2-ethyl-1,3-dioxepane, 2-n-propyl-1,3-dioxepane, 2-isopropyl-1,3-dioxepane, 2-n-butyl-1,3-dioxepane, 2-isobutyl-1,3-dioxepane, 2-pentyl-1,3-dioxepane, 2-hexyl-1,3-dioxepane, 2-heptyl-1,3-dioxepane, 2-octyl-1,3-dioxepane, 2-decyl-1,3-dioxepane, 2-dodecyl-1,3-dioxepane, 2-phenyl-1,3-dioxepane, 2-benzyl-1,3-dioxepane, 2,2-dimethyl-1,3-dioxepane, 2-ethyl-2-methyl-1,3-dioxepane, 2-n-propyl-2-methyl-1,3-dioxepane, 2-isopropyl-2-methyl-1,3-dioxepane, 2-n-butyl-2-methyl-1,3-dioxepane, 2-isobutyl-2-methyl-1,3-dioxepane, 2-methyl-2-pentyl-1,3-dioxepane, 2-hexyl-2-methyl-1,3-dioxepane, 2-heptyl-2-methyl-1,3-dioxepane, 2-octyl-2-methyl-1,3-dioxepane, 2-decyl-2-methyl-1,3-dioxepane, 2-dodecyl-2-methyl-1,3-dioxepane, 2-phenyl-2-methyl-1,3-dioxepane, 2-benzyl-2-methyl-1,3-dioxepane, 2,2-diethyl-1,3-dioxepane, 2-ethyl-2-n-propyl-1,3-dioxepane, 2-ethyl-2-isopropyl-1,3-dioxepane, 2-ethyl-2-n-butyl-1,3-dioxepane, 2-ethyl-2-isobutyl-1,3-dioxepane, 2-ethyl-2-pentyl-1,3-dioxepane, 2-ethyl-2-hexyl-1,3-dioxepane, 2-ethyl-2-heptyl-1,3-dioxepane, 2-ethyl-2-octyl-1,3-dioxepane, 2-ethyl-2-decyl-1,3-dioxepane, 2-ethyl-2-dodecyl-1,3-dioxepane, 2-ethyl-2-phenyl-1,3-dioxepane, 2-benzyl-2-ethyl-1,3-dioxepane, 2,2-di-n-propyl-1,3-dioxepane, 2-isopropyl-2-n-propyl-1,3-dioxepane, 2-n-propyl-2-n-butyl-1,3-dioxepane, 2-isobutyl-2-n-propyl-1,3-dioxepane, 2-pentyl-2-n-propyl-1,3-dioxepane, 2-hexyl-2-n-propyl-1,3-dioxepane, 2-heptyl-2-n-propyl-1,3-dioxepane, 2-octyl-2-n-propyl-1,3-dioxepane, 2-decyl-2-n-propyl-1,3-dioxepane, 2-dodecyl-2-n-propyl-1,3-dioxepane, 2-phenyl-2-n-propyl-1,3-dioxepane, 2-benzyl-2-n-propyl-1,3-dioxepane, 2,2-diisopropyl-1,3-dioxepane, 2-isopropyl-2-n-butyl-1,3-dioxepane, 2-isobutyl-2-isopropyl-1,3-dioxepane, 2-isopropyl-2-pentyl-1,3-dioxepane, 2-hexyl-2-isopropyl-1,3-dioxepane, 2-heptyl-2-isopropyl-1,3-dioxepane, 2-isopropyl-2-octyl-1,3-dioxepane, 2-decyl-2-isopropyl-1,3-dioxepane, 2-dodecyl-2-isopropyl-1,3-dioxepane, 2-isopropyl-2-phenyl-1,3-dioxepane, 2-benzyl-2-isopropyl-1,3-dioxepane, 2,2-di-n-butyl-1,3-dioxepane, 2-isobutyl-2-n-butyl-1,3-dioxepane, 2-n-butyl-2-pentyl-1,3-dioxepane, 2-n-butyl-2-hexyl-1,3-dioxepane, 2-n-butyl-2-heptyl-1,3-dioxepane, 2-n-butyl-2-octyl-1,3-dioxepane, 2-n-butyl-2-decyl-1,3-dioxepane, 2-n-butyl-2-dodecyl-1,3-dioxepane, 2-n-butyl-2-phenyl-1,3-dioxepane, 2-benzyl-2-n-butyl-1,3-dioxepane, 2,2-diisobutyl-1,3-dioxepane, 2-isobutyl-2-pentyl-1,3-dioxepane, 2-hexyl-2-isobutyl-1,3-dioxepane, 2-heptyl-2-isobutyl-1,3-dioxepane, 2-isobutyl-2-octyl-1,3-dioxepane, 2-decyl-2-isobutyl-1,3-dioxepane, 2-dodecyl-2-isobutyl-1,3-dioxepane, 2-isobutyl-2-phenyl-1,3-dioxepane, 2-benzyl-2-isobutyl-1,3-dioxepane, 2,2-dipentyl-1,3-dioxepane, 2-hexyl-2-pentyl-1,3-dioxepane, 2-heptyl-2-pentyl-1,3-dioxepane, 2-octyl-2-pentyl-1,3-dioxepane, 2-decyl-2-pentyl-1,3-dioxepane, 2-dodecyl-2-pentyl-1,3-dioxepane, 2-pentyl-2-phenyl-1,3-dioxepane, 2-benzyl-2-pentyl-1,3-dioxepane, 2,2-dihexyl-1,3-dioxepane, 2-hexyl-2-heptyl-1,3-dioxepane, 2-hexyl-2-octyl-1,3-dioxepane, 2-decyl-2-hexyl-1,3-dioxepane, 2-dodecyl-2-hexyl-1,3-dioxepane, 2-hexyl-2-phenyl-1,3-dioxepane, 2-benzyl-2-hexyl-1,3-dioxepane, 2,2-diheptyl-1,3-dioxepane, 2-heptyl-2-octyl-1,3-dioxepane, 2-decyl-2-heptyl-1,3-dioxepane, 2-dodecyl-2-heptyl-1,3-dioxepane, 2-heptyl-2-phenyl-1,3-dioxepane, 2-benzyl-2-heptyl-1,3-dioxepane, 2,2-dioctyl-1,3-dioxepane, 2-decyl-2-octyl-1,3-dioxepane, 2-dodecyl-2-octyl-1,3-dioxepane, 2-octyl-2-phenyl-1,3-dioxepane, 2-benzyl-2-octyl-1,3-dioxepane, 2,2-didecyl-1,3-dioxepane, 2-decyl-2-dodecyl-1,3-dioxepane, 2-decyl-2-phenyl-1,3-dioxepane, 2-benzyl-2-decyl-1,3-dioxepane, 2,2-didodecyl-1,3-dioxepane, 2-dodecyl-2-phenyl-1,3-dioxepane, 2-benzyl-2-dodecyl-1,3-dioxepane, 2,2-diphenyl-1,3-dioxepane, 2-benzyl-2-phenyl-1,3-dioxepane, and 2,2-dibenzyl-1,3-dioxepane.

Two or more kinds of the compounds represented by formula (I) may be used in combination.

A use amount of the compound represented by formula (I) can be selected from a wide range of 1 mol to 2000 mol based on 1 mol of the titanium atom in the solid catalyst component for olefin polymerization. Particularly, a range of 5 mol to 1000 mol is preferable.

A use amount of the compound represented by formula (I) can also be selected based on a use amount of the organoaluminum compound for forming the solid catalyst for olefin polymerization. Usually, the use amount can be selected in a wide range of 0.01 mol to 10 mol based on 1 mol of an aluminum atom in the organoaluminum compound and, particularly, a range of 0.02 mol to 5 mol is preferable.

Examples of the organoaluminum compound constituting the solid catalyst for olefin polymerization of the present invention include compounds described in U.S. Pat. No. 6,903,041. Among them, preferable is trialkylaluminum, a mixture of trialkylaluminum and dialkylaluminum halide, or alkylalumoxane, and further preferable is triethylaluminum, triisobutylaluminum, a mixture of triethylaluminum and diethylaluminum chloride, or tetraethyldialumoxane.

A use amount of the organoaluminum compound constituting the solid catalyst for olefin polymerization of the present invention is usually 0.5 to 700 mol, preferably 0.8 to 500 mol, and particularly preferably 1 to 200 mol, per mole of the titanium atom in the solid catalyst component for olefin polymerization to be used.

Examples of the aliphatic carboxylate contained in the solid component for olefin polymerization constituting the catalyst of the present invention include a compound represented by formula (II):

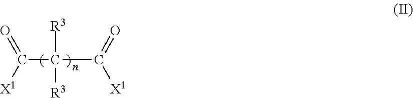

wherein n is an integer satisfying 10≦n≦20; R³ is a hydrogen atom, a halogen atom or a hydrocarbyl group having 1 to 10 carbon atoms, the R³ groups are the same or different; and X¹ is a hydrocarbyloxy group having 1 to 10 carbon atoms and the X¹ groups are the same or different.

Examples of the halogen atom of R³ in formula (II) include a fluorine atom, a chlorine atom, a bromine atom or an iodine atom, and preferable is a fluorine atom, a chlorine atom or a bromine atom.

Examples of the hydrocarbyl group of R³ in formula (II) include an alkyl group, an aralkyl group, an aryl group, and an alkenyl group, and these may have a halogen atom, a hydrocarbyloxy group, a nitro group, a sulfonyl group, a silyl group, and the like, as a substituent.

Examples of the alkyl group of R³ include a linear alkyl group such as a methyl group, an ethyl group, a n-propyl group, a n-butyl group, a n-pentyl group, a n-hexyl group, a n-heptyl group, and a n-octyl group; a branched alkyl group such as an isopropyl group, an isobutyl group, a tert-butyl group, an isopentyl group, a neopentyl group, and a 2-ethylhexyl group; and a cyclic alkyl group such as a cyclopropyl group, a cyclobutyl group, a cyclopentyl group, a cyclohexyl group, a cycloheptyl group, and a cyclooctyl group, and preferable is a linear, branched or cyclic alkyl group having 1 to 10 carbon atoms and more preferable is a linear or branched alkyl group having 1 to 10 carbon atoms.

Examples of the aralkyl group of R³ include a benzyl group and a phenethyl group, and preferable is an aralkyl group having 7 to 10 carbon atoms. Examples of the aryl group of R³ include a phenyl group, a tolyl group, and a xylyl group, and preferable is an aryl group having 6 to 10 carbon atoms. Examples of the alkenyl group of R³ include a linear alkenyl group such as a vinyl group, an allyl group, a 3-butenyl group, and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group, and preferable is an alkenyl group having 2 to 10 carbon atoms.

R³ in formula (II) is preferably a hydrogen atom, or a linear or branched alkyl group having 1 to 10 carbon atoms.

Examples of the hydrocarbyloxy group of X¹ in formula (II) include an alkoxy group, an aralkyloxy group, an aryloxy group, and an alkenyloxy group, and these may have a halogen atom, a nitro group, a sulfonyl group, a silyl group, and the like, as a substituent. Examples of the alkoxy group of X¹ include a linear alkoxy group such as a methoxy group, an ethoxy group, a n-propoxy group, a n-butoxy group, a n-pentyloxy group, a n-hexyloxy group, a n-heptyloxy group, a n-octyloxy group, and a n-decyloxy group; a branched alkoxy group such as an isopropoxy group, an isobutoxy group, a tert-butoxy group, an isopentyloxy group, a neopentyloxy group, an isoamyloxy group, and a 2-ethylhexyloxy group; and a cyclic alkoxy group such as a cyclopropyloxy group, a cyclobutyloxy group, a cyclopentyloxy group, a cyclohexyloxy group, a cycloheptyloxy group, and a cyclooctyloxy group, and preferable is a linear or branched alkoxy group having 1 to 10 carbon atoms.

Examples of the aralkyloxy group of X¹ include a benzyloxy group and a phenethyloxy group, and preferable is an aralkyloxy group having 7 to 10 carbon atoms. Examples of the aryloxy group of X¹ include a phenoxy group, a methylphenoxy group, and a mesityloxy group, and preferable is an aryloxy group having 7 to 10 carbon atoms. Examples of the alkenyloxy group of X¹ include a linear alkenyloxy group such as a vinyloxy group, an allyloxy group, a 3-butenyloxy group, and a 5-hexenyloxy group; a branched alkenyloxy group such as an isobutenyloxy group and a 4-methyl-3-pentenyloxy group; and a cyclic alkenyloxy group such as a 2-cyclohexenyloxy group and a 3-cyclohexenyloxy group, and preferable is a linear or branched alkenyloxy group having 2 to 10 carbon atoms.

X¹ in formula (II) is preferably a linear or branched alkoxy group having 1 to 10 carbon atoms.

And, n in formula (II) is an integer satisfying 10≦n≦20, more preferably an integer satisfying 10≦n≦18, further preferably an integer satisfying 10≦n≦16, and particularly preferably an integer satisfying 10≦n≦14.

Examples of the compound represented by formula (II) in which n is 10 include the following compounds: dimethyl dodecanedioate, diethyl dodecanedioate, dipropyl dodecanedioate, diisopropyl dodecanedioate, dibutyl dodecanedioate, diisobutyl dodecanedioate, dipentyl dodecanedioate, diisopentyl dodecanedioate, dihexyl dodecanedioate, diisohexyl dodecanedioate, diheptyl dodecanedioate, diisoheptyl dodecanedioate, dioctyl dodecanedioate, diisooctyl dodecanedioate, bis(2-ethylhexyl) dodecanedioate, dimethyl α-methyldodecanedioate, diethyl α-methyldodecanedioate, dipropyl α-methyldodecanedioate, diisopropyl α-methyldodecanedioate, dibutyl α-methyldodecanedioate, diisobutyl α-methyldodecanedioate, dipentyl α-methyldodecanedioate, diisopentyl α-methyldodecanedioate, dihexyl α-methyldodecanedioate, diisohexyl α-methyldodecanedioate, diheptyl α-methyldodecanedioate, diisoheptyl α-methyldodecanedioate, dioctyl α-methyldodecanedioate, diisooctyl α-methyldodecanedioate, bis(2-ethylhexyl) α-methyldodecanedioate, dimethyl α-ethyldodecanedioate, diethyl α-ethyldodecanedioate, dipropyl α-ethyldodecanedioate, diisopropyl α-ethyldodecanedioate, dibutyl α-ethyldodecanedioate, diisobutyl α-ethyldodecanedioate, dipentyl α-ethyldodecanedioate, diisopentyl α-ethyldodecanedioate, dihexyl α-ethyldodecanedioate, diisohexyl α-ethyldodecanedioate, diheptyl α-ethyldodecanedioate, diisoheptyl α-ethyldodecanedioate, dioctyl α-ethyldodecanedioate, diisooctyl α-ethyldodecanedioate, bis(2-ethylhexyl) α-ethyldodecanedioate, dimethyl α-isopropyldodecanedioate, diethyl α-isopropyldodecanedioate, dipropyl α-isopropyldodecanedioate, diisopropyl α-isopropyldodecanedioate, dibutyl α-isopropyldodecanedioate, diisobutyl α-isopropyldodecanedioate, dipentyl α-isopropyldodecanedioate, diisopentyl α-isopropyldodecanedioate, dihexyl α-isopropyldodecanedioate, diisohexyl α-isopropyldodecanedioate, diheptyl α-isopropyldodecanedioate, diisoheptyl α-isopropyldodecanedioate, dioctyl α-isopropyldodecanedioate, diisooctyl α-isopropyldodecanedioate, bis(2-ethylhexyl) α-isopropyldodecanedioate, dimethyl β-methyldodecanedioate, diethyl β-methyldodecanedioate, dipropyl β-methyldodecanedioate, diisopropyl β-methyldodecanedioate, dibutyl β-methyldodecanedioate, diisobutyl β-methyldodecanedioate, dipentyl β-methyldodecanedioate, diisopentyl β-methyldodecanedioate, dihexyl β-methyldodecanedioate, diisohexyl β-methyldodecanedioate, diheptyl β-methyldodecanedioate, diisoheptyl β-methyldodecanedioate, dioctyl β-methyldodecanedioate, diisooctyl β-methyldodecanedioate, bis(2-ethylhexyl) β-methyldodecanedioate, dimethyl β-ethyldodecanedioate, diethyl β-ethyldodecanedioate, dipropyl β-ethyldodecanedioate, diisopropyl ethyldodecanedioate, dibutyl β-ethyldodecanedioate, diisobutyl β-ethyldodecanedioate, dipentyl β-ethyldodecanedioate, diisopentyl β-ethyldodecanedioate, dihexyl β-ethyldodecanedioate, diisohexyl β-ethyldodecanedioate, diheptyl β-ethyldodecanedioate, diisoheptyl β-ethyldodecanedioate, dioctyl β-ethyldodecanedioate, diisooctyl β-ethyldodecanedioate, bis(2-ethylhexyl) β-ethyldodecanedioate, dimethyl β-isopropyldodecanedioate, diethyl β-isopropyldodecanedioate, dipropyl β-isopropyldodecanedioate, diisopropyl β-isopropyldodecanedioate, dibutyl β-isopropyldodecanedioate, diisobutyl β-isopropyldodecanedioate, dipentyl β-isopropyldodecanedioate, diisopentyl β-isopropyldodecanedioate, dihexyl β-isopropyldodecanedioate, diisohexyl β-isopropyldodecanedioate, diheptyl β-isopropyldodecanedioate, diisoheptyl β-isopropyldodecanedioate, dioctyl β-isopropyldodecanedioate, diisooctyl β-isopropyldodecanedioate, bis(2-ethylhexyl) β-isopropyldodecanedioate, dimethyl γ-methyldodecanedioate, diethyl γ-methyldodecanedioate, dipropyl γ-methyldodecanedioate, diisopropyl γ-methyldodecanedioate, dibutyl γ-methyldodecanedioate, diisobutyl γ-methyldodecanedioate, dipentyl γ-methyldodecanedioate, diisopentyl γ-methyldodecanedioate, dihexyl γ-methyldodecanedioate, diisohexyl γ-methyldodecanedioate, diheptyl γ-methyldodecanedioate, diisoheptyl γ-methyldodecanedioate, dioctyl γ-methyldodecanedioate, diisooctyl γ-methyldodecanedioate, bis(2-ethylhexyl) γ-methyldodecanedioate, dimethyl γ-ethyldodecanedioate, diethyl γ-ethyldodecanedioate, dipropyl γ-ethyldodecanedioate, diisopropyl γ-ethyldodecanedioate, dibutyl γ-ethyldodecanedioate, diisobutyl rethyldodecanedioate, dipentyl γ-ethyldodecanedioate, diisopentyl γ-ethylddodecanedioate, dihexyl γ-ethyldodecanedioate, diisohexyl γ-ethyldodecanedioate, diheptyl γ-ethyldodecanedioate, diisoheptyl γ-ethyldodecanedioate, dioctyl γ-ethyldodecanedioate, diisooctyl γ-ethyldodecanedioate, bis(2-ethylhexyl) γ-ethyldodecanedioate, dimethyl γ-isopropyldodecanedioate, diethyl γ-isopropyldodecanedioate, dipropyl γ-isopropyldodecanedioate, diisopropyl γ-isopropyldodecanedioate, dibutyl γ-isopropyldodecanedioate, diisobutyl γ-isopropyldodecanedioate, dipentyl γ-isopropyldodecanedioate, diisopentyl γ-isopropyldodecanedioate, dihexyl γ-isopropyldodecanedioate, diisohexyl γisopropyldodecanedioate, diheptyl γ-isopropyldodecanedioate, diisoheptyl γ-isopropyldodecanedioate, dioctyl γ-isopropyldodecanedioate, diisooctyl γ-isopropyldodecanedioate, bis(2-ethylhexyl) γ-isopropyldodecanedioate, dimethyl α,β-dimethyldodecanedioate, diethyl α,β-dimethyldodecanedioate, dipropyl α,β-dimethyldodecanedioate, diisopropyl α,β-dimethyldodecanedioate, dibutyl α,β-dimethyldodecanedioate, diisobutyl α,β-dimethyldodecanedioate, dipentyl α,β-dimethyldodecanedioate, diisopentyl α,β-dimethyldodecanedioate, dihexyl α,β-dimethyldodecanedioate, diisohexyl α,β-dimethyldodecanedioate, diheptyl α,β-dimethyldodecanedioate, diisoheptyl α,β-dimethyldodecanedioate, dioctyl α,β-dimethyldodecanedioate, diisooctyl α,β-dimethyldodecanedioate, bis(2-ethylhexyl) α,β-dimethyldodecanedioate, dimethyl α,β-diethyldodecanedioate, diethyl α,β-diethyldodecanedioate, dipropyl α,β-diethyldodecanedioate, diisopropyl α,β-diethyldodecanedioate, dibutyl α,β-diethyldodecanedioate, diisobutyl α,β-diethyldodecanedioate, dipentyl α,β-diethyldodecanedioate, diisopentyl α,β-diethyldodecanedioate, dihexyl α,β-diethyldodecanedioate, diisohexyl α,β-diethyldodecanedioate, diheptyl α,β-diethyldodecanedioate, diisoheptyl α,β-diethyldodecanedioate, dioctyl α,β-diethyldodecanedioate, diisooctyl α,β-diethyldodecanedioate, bis(2-ethylhexyl) α,β-diethyldodecanedioate, dimethyl α,β-diisopropyldodecanedioate, diethyl α,β-diisopropyldodecanedioate, dipropyl α,β-diisopropyldodecanedioate, diisopropyl α,β-diisopropyldodecanedioate, dibutyl α,β-diisopropyldodecanedioate, diisobutyl α,β-diisopropyldodecanedioate, dipentyl α,β-diisopropyldodecanedioate, diisopentyl α,β-diisopropyldodecanedioate, dihexyl α,β-diisopropyldodecanedioate, diisohexyl α,β-diisopropyldodecanedioate, diheptyl α,β-diisopropyldodecanedioate, diisoheptyl α,β-diisopropyldodecanedioate, dioctyl α,β-diisopropyldodecanedioate, diisooctyl α,β-diisopropyldodecanedioate, and bis(2-ethylhexyl) α,β-diisopropyldodecanedioate.

Examples of the compound represented by formula (II) in which n is 11 include the following compounds: dimethyl tridecanedioate, diethyl tridecanedioate, dipropyl tridecanedioate, diisopropyl tridecanedioate, dibutyl tridecanedioate, diisobutyl tridecanedioate, dipentyl tridecanedioate, diisopentyl tridecanedioate, dihexyl tridecanedioate, diisohexyl tridecanedioate, diheptyl tridecanedioate, diisoheptyl tridecanedioate, dioctyl tridecanedioate, diisooctyl tridecanedioate, bis(2-ethylhexyl)tridecanedioate, dimethyl α-methyltridecanedioate, diethyl α-methyltridecanedioate, dipropyl α-methyltridecanedioate, diisopropyl α-methyltridecanedioate, dibutyl α-methyltridecanedioate, diisobutyl α-methyltridecanedioate, dipentyl α-methyltridecanedioate, diisopentyl α-methyltridecanedioate, dihexyl α-methyltridecanedioate, diisohexyl α-methyltridecanedioate, diheptyl α-methyltridecanedioate, diisoheptyl α-methyltridecanedioate, dioctyl α-methyltridecanedioate, diisooctyl α-methyltridecanedioate, bis(2-ethylhexyl) α-methyltridecanedioate, dimethyl α-ethyltridecanedioate, diethyl α-ethyltridecanedioate, dipropyl α-ethyltridecanedioate, diisopropyl α-ethyltridecanedioate, dibutyl α-ethyltridecanedioate, diisobutyl α-ethyltridecanedioate, dipentyl α-ethyltridecanedioate, diisopentyl α-ethyltridecanedioate, dihexyl α-ethyltridecanedioate, diisohexyl α-ethyltridecanedioate, diheptyl α-ethyltridecanedioate, diisoheptyl α-ethyltridecanedioate, dioctyl α-ethyltridecanedioate, diisooctyl α-ethyltridecanedioate, bis(2-ethylhexyl) α-ethyltridecanedioate, dimethyl α-isopropyltridecanedioate, diethyl α-isopropyltridecanedioate, dipropyl α-isopropyltridecanedioate, diisopropyl α-isopropyltridecanedioate, dibutyl α-isopropyltridecanedioate, diisobutyl α-isopropyltridecanedioate, dipentyl α-isopropyltridecanedioate, diisopentyl α-isopropyltridecanedioate, dihexyl α-isopropyltridecanedioate, diisohexyl α-isopropyltridecanedioate, diheptyl α-isopropyltridecanedioate, diisoheptyl α-isopropyltridecanedioate, dioctyl α-isopropyltridecanedioate, diisooctyl α-isopropyltridecanedioate, bis(2-ethylhexyl) α-isopropyltridecanedioate, dimethyl β-methyltridecanedioate, diethyl β-methyltridecanedioate, dipropyl β-methyltridecanedioate, diisopropyl β-methyltridecanedioate, dibutyl β-methyltridecanedioate, diisobutyl β-methyltridecanedioate, dipentyl β-methyltridecanedioate, diisopentyl β-methyltridecanedioate, dihexyl β-methyltridecanedioate, diisohexyl β-methyltridecanedioate, diheptyl β-methyltridecanedioate, diisoheptyl β-methyltridecanedioate, dioctyl β-methyltridecanedioate, diisooctyl β-methyltridecanedioate, bis(2-ethylhexyl) β-methyltridecanedioate, dimethyl β-ethyltridecanedioate, diethyl β-ethyltridecanedioate, dipropyl β-ethyltridecanedioate, diisopropyl β-ethyltridecanedioate, dibutyl β-ethyltridecanedioate, diisobutyl β-ethyltridecanedioate, dipentyl β-ethyltridecanedioate, diisopentyl β-ethyltridecanedioate, dihexyl β-ethyltridecanedioate, diisohexyl β-ethyltridecanedioate, diheptyl β-ethyltridecanedioate, diisoheptyl β-ethyltridecanedioate, dioctyl β-ethyltridecanedioate, diisooctyl β-ethyltridecanedioate, bis(2-ethylhexyl) β-ethyltridecanedioate, dimethyl β-isopropyltridecanedioate, diethyl β-isopropyltridecanedioate, dipropyl β-isopropyltridecanedioate, diisopropyl β-isopropyltridecanedioate, dibutyl β-isopropyltridecanedioate, diisobutyl β-isopropyltridecanedioate, dipentyl β-isopropyltridecanedioate, diisopentyl β-isopropyltridecanedioate, dihexyl β-isopropyltridecanedioate, diisohexyl β-isopropyltridecanedioate, diheptyl β-isopropyltridecanedioate, diisoheptyl β-isopropyltridecanedioate, dioctyl β-isopropyltridecanedioate, diisooctyl β-isopropyltridecanedioate, bis(2-ethylhexyl) β-isopropyltridecanedioate, dimethyl rmethyltridecanedioate, diethyl γ-methyltridecanedioate, dipropyl γ-methyltridecanedioate, diisopropyl γ-methyltridecanedioate, dibutyl γ-methyltridecanedioate, diisobutyl γ-methyltridecanedioate, dipentyl γ-methyltridecanedioate, diisopentyl γ-methyltridecanedioate, dihexyl γ-methyltridecanedioate, diisohexyl γ-methyltridecanedioate, diheptyl γ-methyltridecanedioate, diisoheptyl γ-methyltridecanedioate, dioctyl γ-methyltridecanedioate, diisooctyl γ-methyltridecanedioate, bis(2-ethylhexyl) γ-methyltridecanedioate, dimethyl γ-ethyltridecanedioate, diethyl γ-ethyltridecanedioate, dipropyl γ-ethyltridecanedioate, diisopropyl γ-ethyltridecanedioate, dibutyl γ-ethyltridecanedioate, diisobutyl ethyltridecanedioate, dipentyl γ-ethyltridecanedioate, diisopentyl γ-ethyltridecanedioate, dihexyl γ-ethyltridecanedioate, diisohexyl γ-ethyltridecanedioate, diheptyl γ-ethyltridecanedioate, diisoheptyl γ-ethyltridecanedioate, dioctyl γ-ethyltridecanedioate, diisooctyl γ-ethyltridecanedioate, bis(2-ethylhexyl) γ-ethyltridecanedioate, dimethyl γ-isopropyltridecanedioate, diethyl γ-isopropyltridecanedioate, dipropyl γ-isopropyltridecanedioate, diisopropyl γ-isopropyltridecanedioate, dibutyl γ-isopropyltridecanedioate, diisobutyl γ-isopropyltridecanedioate, dipentyl γ-isopropyltridecanedioate, diisopentyl γ-isopropyltridecanedioate, dihexyl γ-isopropyltridecanedioate, diisohexyl γ-isopropyltridecanedioate, diheptyl γ-isopropyltridecanedioate, diisoheptyl γ-isopropyltridecanedioate, dioctyl γ-isopropyltridecanedioate, diisooctyl γ-isopropyltridecanedioate, bis(2-ethylhexyl) γ-isopropyltridecanedioate, dimethyl α,β-dimethyltridecanedioate, diethyl α,β-dimethyltridecanedioate, dipropyl α,β-dimethyltridecanedioate, diisopropyl α,β-dimethyltridecanedioate, dibutyl α,β-dimethyltridecanedioate, diisobutyl α,β-dimethyltridecanedioate, dipentyl α,β-dimethyltridecanedioate, diisopentyl α,β-dimethyltridecanedioate, dihexyl α,β-dimethyltridecanedioate, diisohexyl α,β-dimethyltridecanedioate, diheptyl α,β-dimethyltridecanedioate, diisoheptyl α,β-dimethyltridecanedioate, dioctyl α,β-dimethyltridecanedioate, diisooctyl α,β-dimethyltridecanedioate, bis(2-ethylhexyl) α,β-dimethyltridecanedioate, dimethyl α,β-diethyltridecanedioate, diethyl α,β-diethyltridecanedioate, dipropyl α,β-diethyltridecanedioate, diisopropyl α,β-diethyltridecanedioate, dibutyl α,β-diethyltridecanedioate, diisobutyl α,β-diethyltridecanedioate, dipentyl α,β-diethyltridecanedioate, diisopentyl α,β-diethyltridecanedioate, dihexyl α,β-diethyltridecanedioate, diisohexyl α,β-diethyltridecanedioate, diheptyl α,β-diethyltridecanedioate, diisoheptyl α,β-diethyltridecanedioate, dioctyl α,β-diethyltridecanedioate, diisooctyl α,β-diethyltridecanedioate, bis(2-ethylhexyl) α,β-diethyltridecanedioate, dimethyl α,β-diisopropyltridecanedioate, diethyl α,β-diisopropyltridecanedioate, dipropyl α,β-diisopropyltridecanedioate, diisopropyl α,β-diisopropyltridecanedioate, dibutyl α,β-diisopropyltridecanedioate, diisobutyl α,β-diisopropyltridecanedioate, dipentyl α,β-diisopropyltridecanedioate, diisopentyl α,β-diisopropyltridecanedioate, dihexyl α,β-diisopropyltridecanedioate, diisohexyl α,β-diisopropyltridecanedioate, diheptyl α,β-diisopropyltridecanedioate, diisoheptyl α,β-diisopropyltridecanedioate, dioctyl α,β-diisopropyltridecanedioate, diisooctyl α,β-diisopropyltridecanedioate, and bis(2-ethylhexyl) α,β-diisopropyltridecanedioate.

Examples of the compound represented by formula (II) in which n is 12 include the following compounds: dimethyl tetradecanedioate, diethyl tetradecanedioate, dipropyl tetradecanedioate, diisopropyl tetradecanedioate, dibutyl tetradecanedioate, diisobutyl tetradecanedioate, dipentyl tetradecanedioate, diisopentyl tetradecanedioate, dihexyl tetradecanedioate, diisohexyl tetradecanedioate, diheptyl tetradecanedioate, diisoheptyl tetradecanedioate, dioctyl tetradecanedioate, diisooctyl tetradecanedioate, bis(2-ethylhexyl)tetradecanedioate, dimethyl α-methyltetradecanedioate, diethyl α-methyltetradecanedioate, dipropyl α-methyltetradecanedioate, diisopropyl α-methyltetradecanedioate, dibutyl α-methyltetradecanedioate, diisobutyl α-methyltetradecanedioate, dipentyl α-methyltetradecanedioate, diisopentyl α-methyltetradecanedioate, dihexyl α-methyltetradecanedioate, diisohexyl α-methyltetradecanedioate, diheptyl α-methyltetradecanedioate, diisoheptyl α-methyltetradecanedioate, dioctyl α-methyltetradecanedioate, diisooctyl α-methyltetradecanedioate, bis(2-ethylhexyl) α-methyltetradecanedioate, dimethyl α-ethyltetradecanedioate, diethyl α-ethyltetradecanedioate, dipropyl α-ethyltetradecanedioate, diisopropyl α-ethyltetradecanedioate, dibutyl α-ethyltetradecanedioate, diisobutyl α-ethyltetradecanedioate, dipentyl α-ethyltetradecanedioate, diisopentyl α-ethyltetradecanedioate, dihexyl α-ethyltetradecanedioate, diisohexyl α-ethyltetradecanedioate, diheptyl α-ethyltetradecanedioate, diisoheptyl α-ethyltetradecanedioate, dioctyl α-ethyltetradecanedioate, diisooctyl α-ethyltetradecanedioate, bis(2-ethylhexyl) α-ethyltetradecanedioate, dimethyl α-isopropyltetradecanedioate, diethyl α-isopropyltetradecanedioate, dipropyl α-isopropyltetradecanedioate, diisopropyl α-isopropyltetradecanedioate, dibutyl α-isopropyltetradecanedioate, diisobutyl α-isopropyltetradecanedioate, dipentyl α-isopropyltetradecanedioate, diisopentyl α-isopropyltetradecanedioate, dihexyl α-isopropyltetradecanedioate, diisohexyl α-isopropyltetradecanedioate, diheptyl α-isopropyltetradecanedioate, diisoheptyl α-isopropyltetradecanedioate, dioctyl α-isopropyltetradecanedioate, diisooctyl α-isopropyltetradecanedioate, bis(2-ethylhexyl) α-isopropyltetradecanedioate, dimethyl β-methyltetradecanedioate, diethyl β-methyltetradecanedioate, dipropyl β-methyltetradecanedioate, diisopropyl β-methyltetradecanedioate, dibutyl β-methyltetradecanedioate, diisobutyl β-methyltetradecanedioate, dipentyl γ-methyltetradecanedioate, diisopentyl β-methyltetradecanedioate, dihexyl β-methyltetradecanedioate, diisohexyl β-methyltetradecanedioate, diheptyl β-methyltetradecanedioate, diisoheptyl methyltetradecanedioate, dioctyl γ-methyltetradecanedioate, diisooctyl β-methyltetradecanedioate, bis(2-ethylhexyl) β-methyltetradecanedioate, dimethyl β-ethyltetradecanedioate, diethyl β-ethyltetradecanedioate, dipropyl β-ethyltetradecanedioate, diisopropyl β-ethyltetradecanedioate, dibutyl β-ethyltetradecanedioate, diisobutyl β-ethyltetradecanedioate, dipentyl β-ethyltetradecanedioate, diisopentyl β-ethyltetradecanedioate, dihexyl β-ethyltetradecanedioate, diisohexyl β-ethyltetradecanedioate, diheptyl β-ethyltetradecanedioate, diisoheptyl β-ethyltetradecanedioate, dioctyl β-ethyltetradecanedioate, diisooctyl β-ethyltetradecanedioate, bis(2-ethylhexyl) β-ethyltetradecanedioate, dimethyl β-isopropyltetradecanedioate, diethyl β-isopropyltetradecanedioate, dipropyl β-isopropyltetradecanedioate, diisopropyl β-isopropyltetradecanedioate, dibutyl β-isopropyltetradecanedioate, diisobutyl β-isopropyltetradecanedioate, dipentyl β-isopropyltetradecanedioate, diisopentyl isopropyltetradecanedioate, dihexyl β-isopropyltetradecanedioate, diisohexyl β-isopropyltetradecanedioate, diheptyl β-isopropyltetradecanedioate, diisoheptyl pisopropyltetradecanedioate, dioctyl β-isopropyltetradecanedioate, diisooctyl β-isopropyltetradecanedioate, bis(2-ethylhexyl) β-isopropyltetradecanedioate, dimethyl γ-methyltetradecanedioate, diethyl γ-methyltetradecanedioate, dipropyl γ-methyltetradecanedioate, diisopropyl γ-methyltetradecanedioate, dibutyl methyltetradecanedioate, diisobutyl γ-methyltetradecanedioate, dipentyl γ-methyltetradecanedioate, diisopentyl γ-methyltetradecanedioate, dihexyl γ-methyltetradecanedioate, diisohexyl γ-methyltetradecanedioate, diheptyl γ-methyltetradecanedioate, diisoheptyl γ-methyltetradecanedioate, dioctyl r methyltetradecanedioate, diisooctyl γ-methyltetradecanedioate, bis(2-ethylhexyl) γ-methyltetradecanedioate, dimethyl rethyltetradecanedioate, diethyl rethyltetradecanedioate, dipropyl rethyltetradecanedioate, diisopropyl rethyltetradecanedioate, dibutyl γ-ethyltetradecanedioate, diisobutyl γ-ethyltetradecanedioate, dipentyl γ-ethyltetradecanedioate, diisopentyl γ-ethyltetradecanedioate, dihexyl γ-ethyltetradecanedioate, diisohexyl γ-ethyltetradecanedioate, diheptyl γ-ethyltetradecanedioate, diisoheptyl γ-ethyltetradecanedioate, dioctyl γ-ethyltetradecanedioate, diisooctyl γ-ethyltetradecanedioate, bis(2-ethylhexyl) γ-ethyltetradecanedioate, dimethyl γ-isopropyltetradecanedioate, diethyl γ-isopropyltetradecanedioate, dipropyl γ-isopropyltetradecanedioate, diisopropyl γ-isopropyltetradecanedioate, dibutyl γ-isopropyltetradecanedioate, diisobutyl γ-isopropyltetradecanedioate, dipentyl γ-isopropyltetradecanedioate, diisopentyl γ-isopropyltetradecanedioate, dihexyl risopropyltetradecanedioate, diisohexyl risopropyltetradecanedioate, diheptyl risopropyltetradecanedioate, diisoheptyl γ-isopropyltetradecanedioate, dioctyl γ-isopropyltetradecanedioate, diisooctyl risopropyltetradecanedioate, bis(2-ethylhexyl) γ-isopropyltetradecanedioate, dimethyl α,β-dimethyltetradecanedioate, diethyl α,β-dimethyltetradecanedioate, dipropyl α,β-dimethyltetradecanedioate, diisopropyl α,β-dimethyltetradecanedioate, dibutyl α,β-dimethyltetradecanedioate, diisobutyl α,β-dimethyltetradecanedioate, dipentyl α,β-dimethyltetradecanedioate, diisopentyl α,β-dimethyltetradecanedioate, dihexyl α,β-dimethyltetradecanedioate, diisohexyl α,β-dimethyltetradecanedioate, diheptyl α,β-dimethyltetradecanedioate, diisoheptyl α,β-dimethyltetradecanedioate, dioctyl α,β-dimethyltetradecanedioate, diisooctyl α,β-dimethyltetradecanedioate, bis(2-ethylhexyl) α,β-dimethyltetradecanedioate, dimethyl α,β-diethyltetradecanedioate, diethyl α,β-diethyltetradecanedioate, dipropyl α,β-diethyltetradecanedioate, diisopropyl α,β-diethyltetradecanedioate, dibutyl α,β-diethyltetradecanedioate, diisobutyl α,β-diethyltetradecanedioate, dipentyl α,β-diethyltetradecanedioate, diisopentyl α,β-diethyltetradecanedioate, dihexyl α,β-diethyltetradecanedioate, diisohexyl α,β-diethyltetradecanedioate, diheptyl α,β-diethyltetradecanedioate, diisoheptyl α,β-diethyltetradecanedioate, dioctyl α,β-diethyltetradecanedioate, diisooctyl α,β-diethyltetradecanedioate, bis(2-ethylhexyl) α,β-diethyltetradecanedioate, dimethyl α,β-diisopropyltetradecanedioate, diethyl α,β-diisopropyltetradecanedioate, dipropyl α,β-diisopropyltetradecanedioate, diisopropyl α,β-diisopropyltetradecanedioate, dibutyl α,β-diisopropyltetradecanedioate, diisobutyl α,β-diisopropyltetradecanedioate, dipentyl α,β-diisopropyltetradecanedioate, diisopentyl α,β-diisopropyltetradecanedioate, dihexyl α,β-diisopropyltetradecanedioate, diisohexyl α,β-diisopropyltetradecanedioate, diheptyl α,β-diisopropyltetradecanedioate, diisoheptyl α,β-diisopropyltetradecanedioate, dioctyl α,β-diisopropyltetradecanedioate, diisooctyl α,β-diisopropyltetradecanedioate, and bis(2-ethylhexyl) α,β-diisopropyltetradecanedioate.

Examples of the compound represented by formula (II) in which n is 13 include the following compounds: dimethyl pentadecanedioate, diethyl pentadecanedioate, dipropyl pentadecanedioate, diisopropyl pentadecanedioate, dibutyl pentadecanedioate, diisobutyl pentadecanedioate, dipentyl pentadecanedioate, diisopentyl pentadecanedioate, dihexyl pentadecanedioate, diisohexyl pentadecanedioate, diheptyl pentadecanedioate, diisoheptyl pentadecanedioate, dioctyl pentadecanedioate, diisooctyl pentadecanedioate, bis(2-ethylhexyl) pentadecanedioate, dimethyl α-methylpentadecanedioate, diethyl α-methylpentadecanedioate, dipropyl α-methylpentadecanedioate, diisopropyl α-methylpentadecanedioate, dibutyl α-methylpentadecanedioate, diisobutyl α-methylpentadecanedioate, dipentyl α-methylpentadecanedioate, diisopentyl α-methylpentadecanedioate, dihexyl α-methylpentadecanedioate, diisohexyl α-methylpentadecanedioate, diheptyl α-methylpentadecanedioate, diisoheptyl α-methylpentadecanedioate, dioctyl α-methylpentadecanedioate, diisooctyl α-methylpentadecanedioate, bis(2-ethylhexyl) α-methylpentadecanedioate, dimethyl α-ethylpentadecanedioate, diethyl α-ethylpentadecanedioate, dipropyl α-ethylpentadecanedioate, diisopropyl α-ethylpentadecanedioate, dibutyl α-ethylpentadecanedioate, diisobutyl α-ethylpentadecanedioate, dipentyl α-ethylpentadecanedioate, diisopentyl α-ethylpentadecanedioate, dihexyl α-ethylpentadecanedioate, diisohexyl α-ethylpentadecanedioate, diheptyl α-ethylpentadecanedioate, diisoheptyl α-ethylpentadecanedioate, dioctyl α-ethylpentadecanedioate, diisooctyl α-ethylpentadecanedioate, bis(2-ethylhexyl) α-ethylpentadecanedioate, dimethyl α-isopropylpentadecanedioate, diethyl α-isopropylpentadecanedioate, dipropyl α-isopropylpentadecanedioate, diisopropyl α-isopropylpentadecanedioate, dibutyl α-isopropylpentadecanedioate, diisobutyl α-isopropylpentadecanedioate, dipentyl α-isopropylpentadecanedioate, diisopentyl α-isopropylpentadecanedioate, dihexyl α-isopropylpentadecanedioate, diisohexyl α-isopropylpentadecanedioate, diheptyl α-isopropylpentadecanedioate, diisoheptyl α-isopropylpentadecanedioate, dioctyl α-isopropylpentadecanedioate, diisooctyl α-isopropylpentadecanedioate, bis(2-ethylhexyl) α-isopropylpentadecanedioate, dimethyl β-methylpentadecanedioate, diethyl β-methylpentadecanedioate, dipropyl β-methylpentadecanedioate, diisopropyl methylpentadecanedioate, dibutyl β-methylpentadecanedioate, diisobutyl β-methylpentadecanedioate, dipentyl β-methylpentadecanedioate, diisopentyl β-methylpentadecanedioate, dihexyl β-methylpentadecanedioate, diisohexyl β-methylpentadecanedioate, diheptyl β-methylpentadecanedioate, diisoheptyl β-methylpentadecanedioate, dioctyl β-methylpentadecanedioate, diisooctyl β-methylpentadecanedioate, bis(2-ethylhexyl) β-methylpentadecanedioate, dimethyl β-ethylpentadecanedioate, diethyl β-ethylpentadecanedioate, dipropyl β-ethylpentadecanedioate, diisopropyl ethylpentadecanedioate, dibutyl β-ethylpentadecanedioate, diisobutyl β-ethylpentadecanedioate, dipentyl β-ethylpentadecanedioate, diisopentyl β-ethylpentadecanedioate, dihexyl β-ethylpentadecanedioate, diisohexyl β-ethylpentadecanedioate, diheptyl β-ethylpentadecanedioate, diisoheptyl β-ethylpentadecanedioate, dioctyl β-ethylpentadecanedioate, diisooctyl β-ethylpentadecanedioate, bis(2-ethylhexyl) β-ethylpentadecanedioate, dimethyl β-isopropylpentadecanedioate, diethyl β-isopropylpentadecanedioate, dipropyl β-isopropylpentadecanedioate, diisopropyl β-isopropylpentadecanedioate, dibutyl β-isopropylpentadecanedioate, diisobutyl β-isopropylpentadecanedioate, dipentyl pisopropylpentadecanedioate, diisopentyl β-isopropylpentadecanedioate, dihexyl β-isopropylpentadecanedioate, diisohexyl β-isopropylpentadecanedioate, diheptyl β-isopropylpentadecanedioate, diisoheptyl β-isopropylpentadecanedioate, dioctyl β-isopropylpentadecanedioate, diisooctyl isopropylpentadecanedioate, bis(2-ethylhexyl) β-isopropylpentadecanedioate, dimethyl γ-methylpentadecanedioate, diethyl γ-methylpentadecanedioate, dipropyl γ-methylpentadecanedioate, diisopropyl γ-methylpentadecanedioate, dibutyl γ-methylpentadecanedioate, diisobutyl γ-methylpentadecanedioate, dipentyl γ-methylpentadecanedioate, diisopentyl γ-methylpentadecanedioate, dihexyl γ-methylpentadecanedioate, diisohexyl γ-methylpentadecanedioate, diheptyl γ-methylpentadecanedioate, diisoheptyl γ-methylpentadecanedioate, dioctyl γ-methylpentadecanedioate, diisooctyl γ-methylpentadecanedioate, bis(2-ethylhexyl) γ-methylpentadecanedioate, dimethyl γ-ethylpentadecanedioate, diethyl γ-ethylpentadecanedioate, dipropyl γ-ethylpentadecanedioate, diisopropyl γ-ethylpentadecanedioate, dibutyl γ-ethylpentadecanedioate, diisobutyl γ-ethylpentadecanedioate, dipentyl γ-ethylpentadecanedioate, diisopentyl γ-ethylpentadecanedioate, dihexyl γ-ethylpentadecanedioate, diisohexyl γ-ethylpentadecanedioate, diheptyl γ-ethylpentadecanedioate, diisoheptyl γ-ethylpentadecanedioate, dioctyl γ-ethylpentadecanedioate, diisooctyl γ-ethylpentadecanedioate, bis(2-ethylhexyl) γ-ethylpentadecanedioate, dimethyl γ-isopropylpentadecanedioate, diethyl γ-isopropylpentadecanedioate, dipropyl γ-isopropylpentadecanedioate, diisopropyl γ-isopropylpentadecanedioate, dibutyl γ-isopropylpentadecanedioate, diisobutyl γ-isopropylpentadecanedioate, dipentyl γ-isopropylpentadecanedioate, diisopentyl γ-isopropylpentadecanedioate, dihexyl γ-isopropylpentadecanedioate, diisohexyl γ-isopropylpentadecanedioate, diheptyl γ-isopropylpentadecanedioate, diisoheptyl γ-isopropylpentadecanedioate, dioctyl γ-isopropylpentadecanedioate, diisooctyl γ-isopropylpentadecanedioate, bis(2-ethylhexyl) γ-isopropylpentadecanedioate, dimethyl α,β-dimethylpentadecanedioate, diethyl α,β-dimethylpentadecanedioate, dipropyl α,β-dimethylpentadecanedioate, diisopropyl α,β-dimethylpentadecanedioate, dibutyl α,β-dimethylpentadecanedioate, diisobutyl α,β-dimethylpentadecanedioate, dipentyl α,β-dimethylpentadecanedioate, diisopentyl α,β-dimethylpentadecanedioate, dihexyl α,β-dimethylpentadecanedioate, diisohexyl α,β-dimethylpentadecanedioate, diheptyl α,β-dimethylpentadecanedioate, diisoheptyl α,β-dimethylpentadecanedioate, dioctyl α,β-dimethylpentadecanedioate, diisooctyl α,β-dimethylpentadecanedioate, bis(2-ethylhexyl) α,β-dimethylpentadecanedioate, dimethyl α,β-diethylpentadecanedioate, diethyl α,β-diethylpentadecanedioate, dipropyl α,β-diethylpentadecanedioate, diisopropyl α,β-diethylpentadecanedioate, dibutyl α,β-diethylpentadecanedioate, diisobutyl α,β-diethylpentadecanedioate, dipentyl α,β-diethylpentadecanedioate, diisopentyl α,β-diethylpentadecanedioate, dihexyl α,β-diethylpentadecanedioate, diisohexyl α,β-diethylpentadecanedioate, diheptyl α,β-diethylpentadecanedioate, diisoheptyl α,β-diethylpentadecanedioate, dioctyl α,β-diethylpentadecanedioate, diisooctyl α,β-diethylpentadecanedioate, bis(2-ethylhexyl) α,β-diethylpentadecanedioate, dimethyl α,β-diisopropylpentadecanedioate, diethyl α,β-diisopropylpentadecanedioate, dipropyl α,β-diisopropylpentadecanedioate, diisopropyl α,β-diisopropylpentadecanedioate, dibutyl α,β-diisopropylpentadecanedioate, diisobutyl α,β-diisopropylpentadecanedioate, dipentyl α,β-diisopropylpentadecanedioate, diisopentyl α,β-diisopropylpentadecanedioate, dihexyl α,β-diisopropylpentadecanedioate, diisohexyl α,β-diisopropylpentadecanedioate, diheptyl α,β-diisopropylpentadecanedioate, diisoheptyl α,β-diisopropylpentadecanedioate, dioctyl α,β-diisopropylpentadecanedioate, diisooctyl α,β-diisopropylpentadecanedioate, and bis(2-ethylhexyl) α,β-diisopropylpentadecanedioate.

Examples of the compound represented by formula (II) in which n is 14 include the following compounds: dimethyl hexadecanedioate, diethyl hexadecanedioate, dipropyl hexadecanedioate, diisopropyl hexadecanedioate, dibutyl hexadecanedioate, diisobutyl hexadecanedioate, dipentyl hexadecanedioate, diisopentyl hexadecanedioate, dihexyl hexadecanedioate, diisohexyl hexadecanedioate, diheptyl hexadecanedioate, diisoheptyl hexadecanedioate, dioctyl hexadecanedioate, diisooctyl hexadecanedioate, bis(2-ethylhexyl) hexadecanedioate, dimethyl α-methylhexadecanedioate, diethyl α-methylhexadecanedioate, dipropyl α-methylhexadecanedioate, diisopropyl α-methylhexadecanedioate, dibutyl α-methylhexadecanedioate, diisobutyl α-methylhexadecanedioate, dipentyl α-methylhexadecanedioate, diisopentyl α-methylhexadecanedioate, dihexyl α-methylhexadecanedioate, diisohexyl α-methylhexadecanedioate, diheptyl α-methylhexadecanedioate, diisoheptyl α-methylhexadecanedioate, dioctyl α-methylhexadecanedioate, diisooctyl α-methylhexadecanedioate, bis(2-ethylhexyl) α-methylhexadecanedioate, dimethyl α-ethylhexadecanedioate, diethyl α-ethylhexadecanedioate, dipropyl α-ethylhexadecanedioate, diisopropyl α-ethylhexadecanedioate, dibutyl α-ethylhexadecanedioate, diisobutyl α-ethylhexadecanedioate, dipentyl α-ethylhexadecanedioate, diisopentyl α-ethylhexadecanedioate, dihexyl α-ethylhexadecanedioate, diisohexyl α-ethylhexadecanedioate, diheptyl α-ethylhexadecanedioate, diisoheptyl α-ethylhexadecanedioate, dioctyl α-ethylhexadecanedioate, diisooctyl α-ethylhexadecanedioate, bis(2-ethylhexyl) α-ethylhexadecanedioate, dimethyl α-isopropylhexadecanedioate, diethyl α-isopropylhexadecanedioate, dipropyl α-isopropylhexadecanedioate, diisopropyl α-isopropylhexadecanedioate, dibutyl α-isopropylhexadecanedioate, diisobutyl α-isopropylhexadecanedioate, dipentyl α-isopropylhexadecanedioate, diisopentyl α-isopropylhexadecanedioate, dihexyl α-isopropylhexadecanedioate, diisohexyl α-isopropylhexadecanedioate, diheptyl α-isopropylhexadecanedioate, diisoheptyl α-isopropylhexadecanedioate, dioctyl α-isopropylhexadecanedioate, diisooctyl α-isopropylhexadecanedioate, bis(2-ethylhexyl) α-isopropylhexadecanedioate, dimethyl β-methylhexadecanedioate, diethyl β-methylhexadecanedioate, dipropyl β-methylhexadecanedioate, diisopropyl β-methylhexadecanedioate, dibutyl β-methylhexadecanedioate, diisobutyl β-methylhexadecanedioate, dipentyl β-methylhexadecanedioate, diisopentyl β-methylhexadecanedioate, dihexyl β-methylhexadecanedioate, diisohexyl β-methylhexadecanedioate, diheptyl β-methylhexadecanedioate, diisoheptyl β-methylhexadecanedioate, dioctyl β-methylhexadecanedioate, diisooctyl β-methylhexadecanedioate, bis(2-ethylhexyl) β-methylhexadecanedioate, dimethyl β-ethylhexadecanedioate, diethyl β-ethylhexadecanedioate, dipropyl β-ethylhexadecanedioate, diisopropyl β-ethylhexadecanedioate, dibutyl β-ethylhexadecanedioate, diisobutyl β-ethylhexadecanedioate, dipentyl β-ethylhexadecanedioate, diisopentyl β-ethylhexadecanedioate, dihexyl β-ethylhexadecanedioate, diisohexyl β-ethylhexadecanedioate, diheptyl β-ethylhexadecanedioate, diisoheptyl β-ethylhexadecanedioate, dioctyl β-ethylhexadecanedioate, diisooctyl β-ethylhexadecanedioate, bis(2-ethylhexyl) ethylhexadecanedioate, dimethyl β-isopropylhexadecanedioate, diethyl β-isopropylhexadecanedioate, dipropyl β-isopropylhexadecanedioate, diisopropyl β-isopropylhexadecanedioate, dibutyl β-isopropylhexadecanedioate, diisobutyl β-isopropylhexadecanedioate, dipentyl β-isopropylhexadecanedioate, diisopentyl β-isopropylhexadecanedioate, dihexyl β-isopropylhexadecanedioate, diisohexyl β-isopropylhexadecanedioate, diheptyl β-isopropylhexadecanedioate, diisoheptyl β-isopropylhexadecanedioate, dioctyl β-isopropylhexadecanedioate, diisooctyl β-isopropylhexadecanedioate, bis(2-ethylhexyl) β-isopropylhexadecanedioate, dimethyl methylhexadecanedioate, diethyl γ-methylhexadecanedioate, dipropyl γ-methylhexadecanedioate, diisopropyl γ-methylhexadecanedioate, dibutyl γ-methylhexadecanedioate, diisobutyl γ-methylhexadecanedioate, dipentyl methylhexadecanedioate, diisopentyl γ-methylhexadecanedioate, dihexyl γ-methylhexadecanedioate, diisohexyl γ-methylhexadecanedioate, diheptyl methylhexadecanedioate, diisoheptyl γ-methylhexadecanedioate, dioctyl methylhexadecanedioate, diisooctyl γ-methylhexadecanedioate, bis(2-ethylhexyl) γ-methylhexadecanedioate, dimethyl γ-ethylhexadecanedioate, diethyl γ-ethylhexadecanedioate, dipropyl γ-ethylhexadecanedioate, diisopropyl γ-ethylhexadecanedioate, dibutyl γ-ethylhexadecanedioate, diisobutyl γ-ethylhexadecanedioate, dipentyl γ-ethylhexadecanedioate, diisopentyl γ-ethylhexadecanedioate, dihexyl γ-ethylhexadecanedioate, diisohexyl γ-ethylhexadecanedioate, diheptyl γ-ethylhexadecanedioate, diisoheptyl γ-ethylhexadecanedioate, dioctyl γ-ethylhexadecanedioate, diisooctyl γ-ethylhexadecanedioate, bis(2-ethylhexyl) γ-ethylhexadecanedioate, dimethyl γ-isopropylhexadecanedioate, diethyl γ-isopropylhexadecanedioate, dipropyl γ-isopropylhexadecanedioate, diisopropyl γ-isopropylhexadecanedioate, dibutyl γ-isopropylhexadecanedioate, diisobutyl γ-isopropylhexadecanedioate, dipentyl γ-isopropylhexadecanedioate, diisopentyl γ-isopropylhexadecanedioate, dihexyl γ-isopropylhexadecanedioate, diisohexyl γ-isopropylhexadecanedioate, diheptyl γ-isopropylhexadecanedioate, diisoheptyl γ-isopropylhexadecanedioate, dioctyl γ-isopropylhexadecanedioate, diisooctyl γ-isopropylhexadecanedioate, bis(2-ethylhexyl) risopropylhexadecanedioate, dimethyl α,β-dimethylhexadecanedioate, diethyl α,β-dimethylhexadecanedioate, dipropyl α,β-dimethylhexadecanedioate, diisopropyl α,β-dimethylhexadecanedioate, dibutyl α,β-dimethylhexadecanedioate, diisobutyl α,β-dimethylhexadecanedioate, dipentyl α,β-dimethylhexadecanedioate, diisopentyl α,β-dimethylhexadecanedioate, dihexyl α,β-dimethylhexadecanedioate, diisohexyl α,β-dimethylhexadecanedioate, diheptyl α,β-dimethylhexadecanedioate, diisoheptyl α,β-dimethylhexadecanedioate, dioctyl α,β-dimethylhexadecanedioate, diisooctyl α,β-dimethylhexadecanedioate, bis(2-ethylhexyl) α,β-dimethylhexadecanedioate, dimethyl α,β-diethylhexadecanedioate, diethyl α,β-diethylhexadecanedioate, dipropyl α,β-diethylhexadecanedioate, diisopropyl α,β-diethylhexadecanedioate, dibutyl α,β-diethylhexadecanedioate, diisobutyl α,β-diethylhexadecanedioate, dipentyl α,β-diethylhexadecanedioate, diisopentyl α,β-diethylhexadecanedioate, dihexyl α,β-diethylhexadecanedioate, diisohexyl α,β-diethylhexadecanedioate, diheptyl α,β-diethylhexadecanedioate, diisoheptyl α,β-diethylhexadecanedioate, dioctyl α,β-diethylhexadecanedioate, diisooctyl α,β-diethylhexadecanedioate, bis(2-ethylhexyl) α,β-diethylhexadecanedioate, dimethyl α,β-diisopropylhexadecanedioate, diethyl α,β-diisopropylhexadecanedioate, dipropyl α,β-diisopropylhexadecanedioate, diisopropyl α,β-diisopropylhexadecanedioate, dibutyl α,β-diisopropylhexadecanedioate, diisobutyl α,β-diisopropylhexadecanedioate, dipentyl α,β-diisopropylhexadecanedioate, diisopentyl α,β-diisopropylhexadecanedioate, dihexyl α,β-diisopropylhexadecanedioate, diisohexyl α,β-diisopropylhexadecanedioate, diheptyl α,β-diisopropylhexadecanedioate, diisoheptyl α,β-diisopropylhexadecanedioate, dioctyl α,β-diisopropylhexadecanedioate, diisooctyl α,β-diisopropylhexadecanedioate, and bis(2-ethylhexyl) α,β-diisopropylhexadecanedioate.

Examples of the compound represented by formula (II) in which n is 15 include the following compounds: dimethyl heptadecanedioate, diethyl heptadecanedioate, dipropyl heptadecanedioate, diisopropyl heptadecanedioate, dibutyl heptadecanedioate, diisobutyl heptadecanedioate, dipentyl heptadecanedioate, diisopentyl heptadecanedioate, dihexyl heptadecanedioate, diisohexyl heptadecanedioate, diheptyl heptadecanedioate, diisoheptyl heptadecanedioate, dioctyl heptadecanedioate, diisooctyl heptadecanedioate, bis(2-ethylhexyl) heptadecanedioate, dimethyl α-methylheptadecanedioate, diethyl α-methylheptadecanedioate, dipropyl α-methylheptadecanedioate, diisopropyl α-methylheptadecanedioate, dibutyl α-methylheptadecanedioate, diisobutyl α-methylheptadecanedioate, dipentyl α-methylheptadecanedioate, diisopentyl α-methylheptadecanedioate, dihexyl α-methylheptadecanedioate, diisohexyl α-methylheptadecanedioate, diheptyl α-methylheptadecanedioate, diisoheptyl α-methylheptadecanedioate, dioctyl α-methylheptadecanedioate, diisooctyl α-methylheptadecanedioate, bis(2-ethylhexyl) α-methylheptadecanedioate, dimethyl α-ethylheptadecanedioate, diethyl α-ethylheptadecanedioate, dipropyl α-ethylheptadecanedioate, diisopropyl α-ethylheptadecanedioate, dibutyl α-ethylheptadecanedioate, diisobutyl α-ethylheptadecanedioate, dipentyl α-ethylheptadecanedioate, diisopentyl α-ethylheptadecanedioate, dihexyl α-ethylheptadecanedioate, diisohexyl α-ethylheptadecanedioate, diheptyl α-ethylheptadecanedioate, diisoheptyl α-ethylheptadecanedioate, dioctyl α-ethylheptadecanedioate, diisooctyl α-ethylheptadecanedioate, bis(2-ethylhexyl) α-ethylheptadecanedioate, dimethyl α-isopropylheptadecanedioate, diethyl α-isopropylheptadecanedioate, dipropyl α-isopropylheptadecanedioate, diisopropyl α-isopropylheptadecanedioate, dibutyl α-isopropylheptadecanedioate, diisobutyl α-isopropylheptadecanedioate, dipentyl α-isopropylheptadecanedioate, diisopentyl α-isopropylheptadecanedioate, dihexyl α-isopropylheptadecanedioate, diisohexyl α-isopropylheptadecanedioate, diheptyl α-isopropylheptadecanedioate, diisoheptyl α-isopropylheptadecanedioate, dioctyl α-isopropylheptadecanedioate, diisooctyl α-isopropylheptadecanedioate, bis(2-ethylhexyl) α-isopropylheptadecanedioate, dimethyl β-methylheptadecanedioate, diethyl β-methylheptadecanedioate, dipropyl β-methylheptadecanedioate, diisopropyl β-methylheptadecanedioate, dibutyl β-methylheptadecanedioate, diisobutyl β-methylheptadecanedioate, dipentyl β-methylheptadecanedioate, diisopentyl β-methylheptadecanedioate, dihexyl β-methylheptadecanedioate, diisohexyl β-methylheptadecanedioate, diheptyl β-methylheptadecanedioate, diisoheptyl β-methylheptadecanedioate, dioctyl β-methylheptadecanedioate, diisooctyl β-methylheptadecanedioate, bis(2-ethylhexyl) β-methylheptadecanedioate, dimethyl β-ethylheptadecanedioate, diethyl β-ethylheptadecanedioate, dipropyl β-ethylheptadecanedioate, diisopropyl β-ethylheptadecanedioate, dibutyl β-ethylheptadecanedioate, diisobutyl β-ethylheptadecanedioate, dipentyl β-ethylheptadecanedioate, diisopentyl β-ethylheptadecanedioate, dihexyl β-ethylheptadecanedioate, diisohexyl β-ethylheptadecanedioate, diheptyl β-ethylheptadecanedioate, diisoheptyl β-ethylheptadecanedioate, dioctyl β-ethylheptadecanedioate, diisooctyl β-ethylheptadecanedioate, bis(2-ethylhexyl) β-ethylheptadecanedioate, dimethyl β-isopropylheptadecanedioate, diethyl β-isopropylheptadecanedioate, dipropyl β-isopropylheptadecanedioate, diisopropyl β-isopropylheptadecanedioate, dibutyl β-isopropylheptadecanedioate, diisobutyl β-isopropylheptadecanedioate, dipentyl β-isopropylheptadecanedioate, diisopentyl β-isopropylheptadecanedioate, dihexyl β-isopropylheptadecanedioate, diisohexyl β-isopropylheptadecanedioate, diheptyl β-isopropylheptadecanedioate, diisoheptyl β-isopropylheptadecanedioate, dioctyl β-isopropylheptadecanedioate, diisooctyl β-isopropylheptadecanedioate, bis(2-ethylhexyl) β-isopropylheptadecanedioate, dimethyl γ-methylheptadecanedioate, diethyl γ-methylheptadecanedioate, dipropyl γ-methylheptadecanedioate, diisopropyl γ-methylheptadecanedioate, dibutyl γ-methylheptadecanedioate, diisobutyl γ-methylheptadecanedioate, dipentyl rmethylheptadecanedioate, diisopentyl γ-methylheptadecanedioate, dihexyl γ-methylheptadecanedioate, diisohexyl rmethylheptadecanedioate, diheptyl γ-methylheptadecanedioate, diisoheptyl γ-methylheptadecanedioate, dioctyl γ-methylheptadecanedioate, diisooctyl γ-methylheptadecanedioate, bis(2-ethylhexyl) γ-methylheptadecanedioate, dimethyl γ-ethylheptadecanedioate, diethyl γ-ethylheptadecanedioate, dipropyl γ-ethylheptadecanedioate, diisopropyl γ-ethylheptadecanedioate, dibutyl γ-ethylheptadecanedioate, diisobutyl γ-ethylheptadecanedioate, dipentyl γ-ethylheptadecanedioate, diisopentyl γ-ethylheptadecanedioate, dihexyl γ-ethylheptadecanedioate, diisohexyl γ-ethylheptadecanedioate, diheptyl γ-ethylheptadecanedioate, diisoheptyl γ-ethylheptadecanedioate, dioctyl γ-ethylheptadecanedioate, diisooctyl γ-ethylheptadecanedioate, bis(2-ethylhexyl) γ-ethylheptadecanedioate, dimethyl γ-isopropylheptadecanedioate, diethyl γ-isopropylheptadecanedioate, dipropyl γ-isopropylheptadecanedioate, diisopropyl γ-isopropylheptadecanedioate, dibutyl γ-isopropylheptadecanedioate, diisobutyl γ-isopropylheptadecanedioate, dipentyl γ-isopropylheptadecanedioate, diisopentyl γ-isopropylheptadecanedioate, dihexyl γ-isopropylheptadecanedioate, diisohexyl γ-isopropylheptadecanedioatel, diheptyl γ-isopropylheptadecanedioate, diisoheptyl γ-isopropylheptadecanedioate, dioctyl γ-isopropylheptadecanedioate, diisooctyl γ-isopropylheptadecanedioate, bis(2-ethylhexyl) γ-isopropylheptadecanedioate, dimethyl α,β-dimethylheptadecanedioate, diethyl α,β-dimethylheptadecanedioate, dipropyl α,β-dimethylheptadecanedioate, diisopropyl α,β-dimethylheptadecanedioate, dibutyl α,β-dimethylheptadecanedioate, diisobutyl α,β-dimethylheptadecanedioate, dipentyl α,β-dimethylheptadecanedioate, diisopentyl α,β-dimethylheptadecanedioate, dihexyl α,β-dimethylheptadecanedioate, diisohexyl α,β-dimethylheptadecanedioate, diheptyl α,β-dimethylheptadecanedioate, diisoheptyl α,β-dimethylheptadecanedioate, dioctyl α,β-dimethylheptadecanedioate, diisooctyl α,β-dimethylheptadecanedioate, bis(2-ethylhexyl) α,β-dimethylheptadecanedioate, dimethyl α,β-diethylheptadecanedioate, diethyl α,β-diethylheptadecanedioate, dipropyl α,β-diethylheptadecanedioate, diisopropyl α,β-diethylheptadecanedioate, dibutyl α,β-diethylheptadecanedioate, diisobutyl α,β-diethylheptadecanedioate, dipentyl α,β-diethylheptadecanedioate, diisopentyl α,β-diethylheptadecanedioate, dihexyl α,β-diethylheptadecanedioate, diisohexyl α,β-diethylheptadecanedioate, diheptyl α,β-diethylheptadecanedioate, diisoheptyl α,β-diethylheptadecanedioate, dioctyl α,β-diethylheptadecanedioate, diisooctyl α,β-diethylheptadecanedioate, bis(2-ethylhexyl) α,β-diethylheptadecanedioate, dimethyl α,β-diisopropylheptadecanedioate, diethyl α,β-diisopropylheptadecanedioate, dipropyl α,β-diisopropylheptadecanedioate, diisopropyl α,β-diisopropylheptadecanedioate, dibutyl α,β-diisopropylheptadecanedioate, diisobutyl α,β-diisopropylheptadecanedioate, dipentyl α,β-diisopropylheptadecanedioate, diisopentyl α,β-diisopropylheptadecanedioate, dihexyl α,β-diisopropylheptadecanedioate, diisohexyl α,β-diisopropylheptadecanedioate, diheptyl α,β-diisopropylheptadecanedioate, diisoheptyl α,β-diisopropylheptadecanedioate, dioctyl α,β-diisopropylheptadecanedioate, diisooctyl α,β-diisopropylheptadecanedioate, and bis(2-ethylhexyl) α,β-diisopropylheptadecanedioate.

Examples of the compound represented by formula (II) in which n is 16 include the following compounds: dimethyl octadecanedioate, diethyl octadecanedioate, dipropyl octadecanedioate, diisopropyl octadecanedioate, dibutyl octadecanedioate, diisobutyl octadecanedioate, dipentyl octadecanedioate, diisopentyl octadecanedioate, dihexyl octadecanedioate, diisohexyl octadecanedioate, diheptyl octadecanedioate, diisoheptyl octadecanedioate, dioctyl octadecanedioate, diisooctyl octadecanedioate, bis(2-ethylhexyl) octadecanedioate, dimethyl α-methyloctadecanedioate, diethyl α-methyloctadecanedioate, dipropyl α-methyloctadecanedioate, diisopropyl α-methyloctadecanedioate, dibutyl α-methyloctadecanedioate, diisobutyl methyloctadecanedioate, dipentyl α-methyloctadecanedioate, diisopentyl α-methyloctadecanedioate, dihexyl α-methyloctadecanedioate, diisohexyl α-methyloctadecanedioate, diheptyl α-methyloctadecanedioate, diisoheptyl α-methyloctadecanedioate, dioctyl α-methyloctadecanedioate, diisooctyl α-methyloctadecanedioate, bis(2-ethylhexyl) α-methyloctadecanedioate, dimethyl α-ethyloctadecanedioate, diethyl α-ethyloctadecanedioate, dipropyl α-ethyloctadecanedioate, diisopropyl α-ethyloctadecanedioate, dibutyl α-ethyloctadecanedioate, diisobutyl α-ethyloctadecanedioate, dipentyl α-ethyloctadecanedioate, diisopentyl α-ethyloctadecanedioate, dihexyl α-ethyloctadecanedioate, diisohexyl α-ethyloctadecanedioate, diheptyl α-ethyloctadecanedioate, diisoheptyl α-ethyloctadecanedioate, dioctyl α-ethyloctadecanedioate, diisooctyl α-ethyloctadecanedioate, bis(2-ethylhexyl) α-ethyloctadecanedioate, dimethyl α-isopropyloctadecanedioate, diethyl α-isopropyloctadecanedioate, dipropyl α-isopropyloctadecanedioate, diisopropyl α-isopropyloctadecanedioate, dibutyl α-isopropyloctadecanedioate, diisobutyl α-isopropyloctadecanedioate, dipentyl α-isopropyloctadecanedioate, diisopentyl α-isopropyloctadecanedioate, dihexyl α-isopropyloctadecanedioate, diisohexyl α-isopropyloctadecanedioate, diheptyl α-isopropyloctadecanedioate, diisoheptyl α-isopropyloctadecanedioate, dioctyl α-isopropyloctadecanedioate, diisooctyl α-isopropyloctadecanedioate, bis(2-ethylhexyl) α-isopropyloctadecanedioate, dimethyl β-methyloctadecanedioate, diethyl β-methyloctadecanedioate, dipropyl β-methyloctadecanedioate, diisopropyl β-methyloctadecanedioate, dibutyl β-methyloctadecanedioate, diisobutyl β-methyloctadecanedioate, dipentyl β-methyloctadecanedioate, diisopentyl β-methyloctadecanedioate, dihexyl β-methyloctadecanedioate, diisohexyl β-methyloctadecanedioate, diheptyl β-methyloctadecanedioate, diisoheptyl β-methyloctadecanedioate, dioctyl β-methyloctadecanedioate, diisooctyl β-methyloctadecanedioate, bis(2-ethylhexyl) β-methyloctadecanedioate, dimethyl β-ethyloctadecanedioate, diethyl β-ethyloctadecanedioate, dipropyl β-ethyloctadecanedioate, diisopropyl β-ethyloctadecanedioate, dibutyl ethyloctadecanedioate, diisobutyl β-ethyloctadecanedioate, dipentyl β-ethyloctadecanedioate, diisopentyl β-ethyloctadecanedioate, dihexyl β-ethyloctadecanedioate, diisohexyl β-ethyloctadecanedioate, diheptyl β-ethyloctadecanedioate, diisoheptyl β-ethyloctadecanedioate, dioctyl β-ethyloctadecanedioate, diisooctyl β-ethyloctadecanedioate, bis(2-ethylhexyl) β-ethyloctadecanedioate, dimethyl β-isopropyloctadecanedioate, diethyl β-isopropyloctadecanedioate, dipropyl β-isopropyloctadecanedioate, diisopropyl β-isopropyloctadecanedioate, dibutyl β-isopropyloctadecanedioate, diisobutyl β-isopropyloctadecanedioate, dipentyl β-isopropyloctadecanedioate, diisopentyl 1-isopropyloctadecanedioate, dihexyl β-isopropyloctadecanedioate, diisohexyl β-isopropyloctadecanedioate, diheptyl β-isopropyloctadecanedioate, diisoheptyl β-isopropyloctadecanedioate, dioctyl β-isopropyloctadecane dioate, diisooctyl β-isopropyloctadecanedioate, bis(2-ethylhexyl)-isopropyloctadecanedioate, dimethyl γ-methyloctadecanedioate, diethyl γ-methyloctadecanedioate, dipropyl γ-methyloctadecanedioate, diisopropyl γ-methyloctadecanedioate, dibutyl γ-methyloctadecanedioate, diisobutyl γ-methyloctadecanedioate, dipentyl γ-methyloctadecanedioate, diisopentyl γ-methyloctadecanedioate, dihexyl γ-methyloctadecanedioate, diisohexyl γ-methyloctadecanedioate, diheptyl γ-methyloctadecanedioate, diisoheptyl γ-methyloctadecanedioate, dioctyl γ-methyloctadecanedioate, diisooctyl γ-methyloctadecanedioate, bis(2-ethylhexyl) γ-methyloctadecanedioate, dimethyl γ-ethyloctadecanedioate, diethyl γ-ethyloctadecanedioate, dipropyl γ-ethyloctadecanedioate, diisopropyl γ-ethyloctadecanedioate, dibutyl γ-ethyloctadecanedioate, diisobutyl γ-ethyloctadecanedioate, dip entyl γ-ethyloctadecanedioate, diisopentyl γ-ethyloctadecanedioate, dihexyl γ-ethyloctadecanedioate, diisohexyl γ-ethyloctadecanedioate, diheptyl γ-ethyloctadecanedioate, diisoheptyl γ-ethyloctadecanedioate, dioctyl γ-ethyloctadecanedioate, diisooctyl γ-ethyloctadecanedioate, bis(2-ethylhexyl) γ-ethyloctadecanedioate, dimethyl γ-isopropyloctadecanedioate, diethyl γ-isopropyloctadecanedioate, dipropyl γ-isopropyloctadecanedioate, diisopropyl γ-isopropyloctadecanedioate, dibutyl γ-isopropyloctadecanedioate, diisobutyl γ-isopropyloctadecanedioate, dipentyl γ-isopropyloctadecanedioate, diisopentyl γ-isopropyloctadecanedioate, dihexyl γ-isopropyloctadecanedioate, diisohexyl γ-isopropyloctadecanedioate, diheptyl γ-isopropyloctadecanedioate, diisoheptyl γ-isopropyloctadecanedioate, dioctyl γ-isopropyloctadecanedioate, diisooctyl γ-isopropyloctadecanedioate, bis(2-ethylhexyl) γ-isopropyloctadecanedioate, dimethyl α,β-dimethyloctadecanedioate, diethyl α,β-dimethyloctadecanedioate, dipropyl α,β-dimethyloctadecanedioate, diisopropyl α,β-dimethyloctadecanedioate, dibutyl α,β-dimethyloctadecanedioate, diisobutyl α,β-dimethyloctadecanedioate, dipentyl α,β-dimethyloctadecanedioate, diisopentyl α,β-dimethyloctadecanedioate, dihexyl α,β-dimethyloctadecanedioate, diisohexyl α,β-dimethyloctadecanedioate, diheptyl α,β-dimethyloctadecanedioate, diisoheptyl α,β-dimethyloctadecanedioate, dioctyl α,β-dimethyloctadecanedioate, diisooctyl α,β-dimethyloctadecanedioate, bis(2-ethylhexyl) α,β-dimethyloctadecanedioate, dimethyl α,β-diethyloctadecanedioate, diethyl α,β-diethyloctadecanedioate, dipropyl α,β-diethyloctadecanedioate, diisopropyl α,β-diethyloctadecanedioate, dibutyl α,β-diethyloctadecanedioate, diisobutyl α,β-diethyloctadecanedioate, dipentyl α,β-diethyloctadecanedioate, diisopentyl α,β-diethyloctadecanedioate, dihexyl apdiethyloctadecanedioate, diisohexyl α,β-diethyloctadecanedioate, diheptyl α,β-diethyloctadecanedioate, diisoheptyl α,β-diethyloctadecanedioate, dioctyl α,β-diethyloctadecanedioate, diisooctyl α,β-diethyloctadecanedioate, bis(2-ethylhexyl) α,β-diethyloctadecanedioate, dimethyl α,β-diisopropyloctadecanedioate, diethyl α,β-diisopropyloctadecanedioate, dipropyl α,β-diisopropyloctadecanedioate, diisopropyl α,β-diisopropyloctadecanedioate, dibutyl α,β-diisopropyloctadecanedioate, diisobutyl α,β-dipentyl α,β-diisopropyloctadecanedioate, diisopentyl α,β-diisopropyloctadecanedioate, dihexyl α,β-diisopropyloctadecanedioate, diisohexyl α,β-diisopropyloctadecanedioate, diheptyl α,β-diisopropyloctadecanedioate, diisoheptyl α,β-diisopropyloctadecanedioate, dioctyl α,β-diisopropyloctadecanedioate, diisooctyl α,β-diisopropyloctadecanedioate, and bis(2-ethylhexyl) α,β-diisopropyloctadecanedioate.

Examples of the compound represented by formula (II) in which n is 17 include the following compounds: dimethyl nonadecanedioate, diethyl nonadecanedioate, dipropyl nonadecanedioate, diisopropyl nonadecanedioate, dibutyl nonadecanedioate, diisobutyl nonadecanedioate, dipentyl nonadecanedioate, diisopentyl nonadecanedioate, dihexyl nonadecanedioate, diisohexyl nonadecanedioate, diheptyl nonadecanedioate, diisoheptyl nonadecanedioate, dioctyl nonadecanedioate, diisooctyl nonadecanedioate, bis(2-ethylhexyl) nonadecanedioate, dimethyl α-methylnonadecanedioate, diethyl α-methylnonadecanedioate, dipropyl α-methylnonadecanedioate, diisopropyl α-methylnonadecanedioate, dibutyl α-methylnonadecanedioate, diisobutyl α-methylnonadecanedioate, dipentyl α-methylnonadecanedioate, diisopentyl α-methylnonadecanedioate, dihexyl α-methylnonadecanedioate, diisohexyl α-methylnonadecanedioate, diheptyl α-methylnonadecanedioate, diisoheptyl α-methylnonadecanedioate, dioctyl α-methylnonadecanedioate, diisooctyl α-methylnonadecanedioate, bis(2-ethylhexyl) α-methylnonadecanedioate, dimethyl α-ethylnonadecanedioate, diethyl α-ethylnonadecanedioate, dipropyl α-ethylnonadecanedioate, diisopropyl α-ethylnonadecanedioate, dibutyl α-ethylnonadecanedioate, diisobutyl α-ethylnonadecanedioate, dipentyl α-ethylnonadecanedioate, diisopentyl α-ethylnonadecanedioate, dihexyl α-ethylnonadecanedioate, diisohexyl α-ethylnonadecanedioate, diheptyl α-ethylnonadecanedioate, diisoheptyl α-ethylnonadecanedioate, dioctyl α-ethylnonadecanedioate, diisooctyl α-ethylnonadecanedioate, bis(2-ethylhexyl) α-ethylnonadecanedioate, dimethyl α-isopropylnonadecanedioate, diethyl α-isopropylnonadecanedioate, dipropyl α-isopropylnonadecanedioate, diisopropyl α-isopropylnonadecanedioate, dibutyl α-isopropylnonadecanedioate, diisobutyl α-isopropylnonadecane dioate, dipentyl α-isopropylnonadecanedioate, diisopentyl α-isopropylnonadecanedioate, dihexyl α-isopropylnonadecanedioate, diisohexyl α-isopropylnonadecanedioate, diheptyl α-isopropylnonadecanedioate, diisoheptyl α-isopropylnonadecanedioate, dioctyl α-isopropylnonadecanedioate, diisooctyl α-isopropylnonadecanedioate, bis(2-ethylhexyl) α-isopropylnonadecanedioate, dimethyl β-methylnonadecanedioate, diethyl β-methylnonadecanedioate, dipropyl β-methylnonadecanedioate, diisopropyl β-methylnonadecanedioate, dibutyl β-methylnonadecanedioate, diisobutyl β-methylnonadecanedioate, dipentyl β-methylnonadecanedioate, diisopentyl β-methylnonadecanedioate, dihexyl β-methylnonadecanedioate, diisohexyl β-methylnonadecanedioate, diheptyl β-methylnonadecanedioate, diisoheptyl methylnonadecanedioate, dioctyl β-methylnonadecanedioate, diisooctyl β-methylnonadecanedioate, bis(2-ethylhexyl) β-methylnonadecanedioate, dimethyl β-ethylnonadecanedioate, diethyl(methylnonadecanedioate, dipropyl β-ethylnonadecanedioate, diisopropyl β-ethylnonadecanedioate, dibutyl β-ethylnonadecanedioate, diisobutyl β-ethylnonadecanedioate, dipentyl β-ethylnonadecanedioate, diisopentyl(methylnonadecanedioate, dihexyl β-ethylnonadecanedioate, diisohexyl(methylnonadecanedioate, diheptyl β-ethylnonadecanedioate, diisoheptyl(methylnonadecanedioate, dioctyl β-ethylnonadecanedioate, diisooctyl(methylnonadecanedioate, bis(2-ethylhexyl) β-ethylnonadecanedioate, dimethyl β-isopropylnonadecanedioate, diethyl β-isopropylnonadecanedioate, dipropyl β-isopropylnonadecanedioate, diisopropyl β-isopropylnonadecanedioate, dibutyl 11-isopropylnonadecanedioate, diisobutyl β-isopropylnonadecanedioate, dipentyl β-isopropylnonadecanedioate, diisopentyl β-isopropylnonadecanedioate, dihexyl β-isopropylnonadecanedioate, diisohexyl β-isopropylnonadecanedioate, diheptyl β-isopropylnonadecanedioate, diisoheptyl β-isopropylnonadecanedioate, dioctyl β-isopropylnonadecanedioate, diisooctyl β-isopropylnonadecanedioate, bis(2-ethylhexyl)-isopropylnonadecanedioate, dimethyl γ-methylnonadecanedioate, diethyl rmethylnonadecanedioate, dipropyl γ-methylnonadecanedioate, diisopropyl γ-methylnonadecanedioate, dibutyl γ-methylnonadecanedioate, diisobutyl γ-methylnonadecanedioate, dipentyl γ-methylnonadecanedioate, diisopentyl γ-methylnonadecanedioate, dihexyl γ-methylnonadecanedioate, diisohexyl methylnonadecanedioate, diheptyl γ-methylnonadecanedioate, diisoheptyl γ-methylnonadecanedioate, dioctyl γ-methylnonadecanedioate, diisooctyl γ-methylnonadecanedioate, bis(2-ethylhexyl) γ-methylnonadecanedioate, dimethyl rethylnonadecanedioate, diethyl γ-ethylnonadecanedioate, dipropyl γ-ethylnonadecanedioate, diisopropyl γ-ethylnonadecanedioate, dibutyl γ-ethylnonadecanedioate, diisobutyl γ-ethylnonadecanedioate, dipentyl γ-ethylnonadecanedioate, diisopentyl γ-ethylnonadecanedioate, dihexyl γ-ethylnonadecanedioate, diisohexyl γ-ethylnonadecanedioate, diheptyl γ-ethylnonadecanedioate, diisoheptyl γ-ethylnonadecanedioate, dioctyl γ-ethylnonadecanedioate, diisooctyl γ-ethylnonadecanedioate, bis(2-ethylhexyl) γ-ethylnonadecanedioate, dimethyl γ-isopropylnonadecanedioate, diethyl γ-isopropylnonadecanedioate, dipropyl γ-isopropylnonadecanedioate, diisopropyl γ-isopropylnonadecanedioate, dibutyl γ-isopropylnonadecanedioate, diisobutyl γ-isopropylnonadecanedioate, dipentyl γ-isopropylnonadecanedioate, diisopentyl γ-isopropylnonadecanedioate, dihexyl γ-isopropylnonadecanedioate, diisohexyl γ-isopropylnonadecanedioate, diheptyl γ-isopropylnonadecanedioate, diisoheptyl γ-isopropylnonadecanedioate, dioctyl γ-isopropylnonadecanedioate, diisooctyl γ-isopropylnonadecanedioate, bis(2-ethylhexyl) γ-isopropylnonadecanedioate, dimethyl α,β-dimethylnonadecanedioate, diethyl α,β-dimethylnonadecanedioate, dipropyl α,β-dimethylnonadecanedioate, diisopropyl α,β-dimethylnonadecanedioate, dibutyl α,β-dimethylnonadecanedioate, diisobutyl α,β-dimethylnonadecanedioate, dipentyl α,β-dimethylnonadecanedioate, diisopentyl α,β-dimethylnonadecanedioate, dihexyl α,β-dimethylnonadecanedioate, diisohexyl α,β-dimethylnonadecanedioate, diheptyl α,β-dimethylnonadecanedioate, diisoheptyl α,β-dimethylnonadecanedioate, dioctyl α,β-dimethylnonadecanedioate, diisooctyl α,β-dimethylnonadecanedioate, bis(2-ethylhexyl) α,β-dimethylnonadecanedioate, dimethyl α,β-diethylnonadecanedioate, diethyl α,β-diethylnonadecanedioate, dipropyl α,β-diethylnonadecanedioate, diisopropyl α,β-diethylnonadecanedioate, dibutyl α,β-diethylnonadecanedioate, diisobutyl α,β-diethylnonadecanedioate, dipentyl α,β-diethylnonadecanedioate, diisopentyl α,β-diethylnonadecanedioate, dihexyl α,β-diethylnonadecanedioate, diisohexyl α,β-diethylnonadecanedioate, diheptyl α,β-diethylnonadecanedioate, diisoheptyl α,β-diethylnonadecanedioate, dioctyl α,β-diethylnonadecanedioate, diisooctyl α,β-diethylnonadecanedioate, bis(2-ethylhexyl) α,β-diethylnonadecanedioate, dimethyl α,β-diisopropylnonadecanedioate, diethyl α,β-diisopropylnonadecanedioate, dipropyl α,β-diisopropylnonadecanedioate, diisopropyl α,β-diisopropylnonadecanedioate, dibutyl α,β-diisopropylnonadecanedioate, diisobutyl α,β-diisopropylnonadecanedioate, dipentyl α,β-diisopropylnonadecanedioate, diisopentyl α,β-diisopropylnonadecanedioate, dihexyl α,β-diisopropylnonadecanedioate, diisohexyl α,β-diisopropylnonadecanedioate, diheptyl α,β-diisopropylnonadecanedioate, diisoheptyl α,β-diisopropylnonadecanedioate, dioctyl α,β-diisopropylnonadecanedioate, diisooctyl α,β-diisopropylnonadecanedioate, and bis(2-ethylhexyl) α,β-diisopropylnonadecanedioate.

Examples of the compound represented by formula (II) in which n is 18 include the following compounds: dimethyl eicosanedioate, diethyl eicosanedioate, dipropyl eicosanedioate, diisopropyl eicosanedioate, dibutyl eicosanedioate, diisobutyl eicosanedioate, dipentyl eicosanedioate, diisopentyl eicosanedioate, dihexyl eicosanedioate, diisohexyl eicosanedioate, diheptyl eicosanedioate, diisoheptyl eicosanedioate, dioctyl eicosanedioate, diisooctyl eicosanedioate, bis(2-ethylhexyl) eicosanedioate, dimethyl α-methyleicosanedioate, diethyl α-methyleicosanedioate, dipropyl α-methyleicosanedioate, diisopropyl α-methyleicosanedioate, dibutyl α-methyleicosanedioate, diisobutyl α-methyleicosanedioate, dipentyl α-methyleicosanedioate, diisopentyl α-methyleicosanedioate, dihexyl α-methyleicosanedioate, diisohexyl α-methyleicosanedioate, diheptyl α-methyleicosanedioate, diisoheptyl α-methyleicosanedioate, dioctyl α-methyleicosanedioate, diisooctyl α-methyleicosanedioate, bis(2-ethylhexyl) α-methyleicosanedioate, dimethyl α-ethyleicosanedioate, diethyl α-ethyleicosanedioate, dipropyl α-ethyleicosanedioate, diisopropyl α-ethyleicosanedioate, dibutyl α-ethyleicosanedioate, diisobutyl α-ethyleicosanedioate, dipentyl α-ethyleicosanedioate, diisopentyl α-ethyleicosanedioate, dihexyl α-ethyleicosanedioate, diisohexyl α-ethyleicosanedioate, diheptyl α-ethyleicosanedioate, diisoheptyl α-ethyleicosanedioate, dioctyl α-ethyleicosanedioate, diisooctyl α-ethyleicosanedioate, bis(2-ethylhexyl) α-ethyleicosanedioate, dimethyl α-isopropyleicosanedioate, diethyl α-isopropyleicosanedioate, dipropyl α-isopropyleicosanedioate, diisopropyl α-isopropyleicosanedioate, dibutyl α-isopropyleicosanedioate, diisobutyl α-isopropyleicosanedioate, dipentyl α-isopropyleicosanedioate, diisopentyl α-isopropyleicosanedioate, dihexyl α-isopropyleicosanedioate, diisohexyl α-isopropyleicosanedioate, diheptyl α-isopropyleicosanedioate, diisoheptyl α-isopropyleicosanedioate, dioctyl α-isopropyleicosanedioate, diisooctyl α-isopropyleicosanedioate, bis(2-ethylhexyl) α-isopropyleicosanedioate, dimethyl β-methyleicosanedioate, diethyl β-methyleicosanedioate, dipropyl β-methyleicosanedioate, diisopropyl β-methyleicosanedioate, dibutyl β-methyleicosanedioate, diisobutyl β-methyleicosanedioate, dipentyl β-methyleicosanedioate, diisopentyl β-methyleicosanedioate, dihexyl β-methyleicosanedioate, diisohexyl β-methyleicosanedioate, diheptyl β-methyleicosanedioate, diisoheptyl β-methyleicosanedioate, dioctyl β-methyleicosanedioate, diisooctyl β-methyleicosanedioate, bis(2-ethylhexyl) β-methyleicosanedioate, dimethyl β-ethyleicosanedioate, diethyl β-ethyleicosanedioate, dipropyl β-ethyleicosanedioate, diisopropyl β-ethyleicosanedioate, dibutyl β-ethyleicosanedioate, diisobutyl β-ethyleicosanedioate, dipentyl β-ethyleicosanedioate, diisopentyl β-ethyleicosanedioate, dihexyl β-ethyleicosanedioate, diisohexyl β-ethyleicosanedioate, diheptyl β-ethyleicosanedioate, diisoheptyl β-ethyleicosanedioate, dioctyl β-ethyleicosanedioate, diisooctyl β-ethyleicosanedioate, bis(2-ethylhexyl) β-ethyleicosanedioate, dimethyl β-isopropyleicosanedioate, diethyl β-isopropyleicosanedioate, dipropyl β-isopropyleicosanedioate, diisopropyl β-isopropyleicosanedioate, dibutyl β-isopropyleicosanedioate, diisobutyl α-isopropyleicosanedioate, dipentyl β-isopropyleicosanedioate, diisopentyl β-isopropyleicosanedioate, dihexyl β-isopropyleicosanedioate, diisohexyl β-isopropyleicosanedioate, diheptyl β-isopropyleicosanedioate, diisoheptyl β-isopropyleicosanedioate, dioctyl β-isopropyleicosanedioate, diisooctyl β-isopropyleicosanedioate, bis(2-ethylhexyl) β-isopropyleicosanedioate, dimethyl γ-methyleicosanedioate, diethyl γ-methyleicosanedioate, dipropyl γ-methyleicosanedioate, diisopropyl γ-methyleicosanedioate, dibutyl γ-methyleicosanedioate, diisobutyl γ-methyleicosanedioate, dipentyl γ-methyleicosanedioate, diisopentyl γ-methyleicosanedioate, dihexyl γ-methyleicosanedioate, diisohexyl γ-methyleicosanedioate, diheptyl γ-methyleicosanedioate, diisoheptyl methyleicosanedioate, dioctyl γ-methyleicosanedioate, diisooctyl γ-methyleicosane dioate, bis(2-ethylhexyl) γ-methyleicosanedioate, dimethyl γ-ethyleicosanedioate, diethyl γ-ethyleicosanedioate, dipropyl γ-ethyleicosane dioate, diisopropyl γ-ethyleicosanedioate, dibutyl γ-ethyleicosanedioate, diisobutyl γ-ethyleicosanedioate, dipentyl γ-ethyleicosanedioate, diisopentyl γ-ethyleicosanedioate, dihexyl γ-ethyleicosanedioate, diisohexyl rethyleicosanedioate, diheptyl γ-ethyleicosanedioate, diisoheptyl γ-ethyleicosanedioate, dioctyl γ-ethyleicosanedioate, diisooctyl γ-ethyleicosanedioate, bis(2-ethylhexyl) γ-ethyleicosanedioate, dimethyl γ-isopropyleicosanedioate, diethyl γ-isopropyleicosanedioate, dipropyl γ-isopropyleicosanedioate, diisopropyl γ-isopropyleicosanedioate, dibutyl γ-isopropyleicosanedioate, diisobutyl γ-isopropyleicosanedioate, dipentyl γ-isopropyleicosanedioate, diisopentyl γ-isopropyleicosanedioate, dihexyl γ-isopropyleicosanedioate, diisohexyl γ-isopropyleicosanedioate, diheptyl γ-isopropyleicosanedioate, diisoheptyl γ-isopropyleicosanedioate, dioctyl γ-isopropyleicosanedioate, diisooctyl γ-isopropyleicosanedioate, bis(2-ethylhexyl) γ-isopropyleicosanedioate, dimethyl α,β-dimethyleicosanedioate, diethyl α,β-dimethyleicosanedioate, dipropyl α,β-dimethyleicosanedioate, diisopropyl α,β-dimethyleicosanedioate, dibutyl α,β-dimethyleicosanedioate, diisobutyl α,β-dimethyleicosanedioate, dipentyl α,β-dimethyleicosanedioate, diisopentyl α,β-dimethyleicosanedioate, dihexyl α,β-dimethyleicosanedioate, diisohexyl α,β-dimethyleicosanedioate, diheptyl α,β-dimethyleicosanedioate, diisoheptyl α,β-dimethyleicosanedioate, dioctyl α,β-dimethyleicosanedioate, diisooctyl α,β-dimethyleicosanedioate, bis(2-ethylhexyl) α,β-dimethyleicosanedioate, dimethyl α,β-diethyleicosanedioate, diethyl α,β-diethyleicosanedioate, dipropyl α,β-diethyleicosanedioate, diisopropyl α,β-diethyleicosanedioate, dibutyl α,β-diethyleicosanedioate, diisobutyl α,β-diethyleicosanedioate, dipentyl α,β-diethyleicosanedioate, diisopentyl α,β-diethyleicosanedioate, dihexyl α,β-diethyleicosanedioate, diisohexyl α,β-diethyleicosanedioate, diheptyl α,β-diethyleicosanedioate, diisoheptyl α,β-diethyleicosanedioate, dioctyl α,β-diethyleicosanedioate, diisooctyl α,β-diethyleicosanedioate, bis(2-ethylhexyl) α,β-diethyleicosanedioate, dimethyl α,β-diisopropyleicosanedioate, diethyl α,β-diisopropyleicosanedioate, dipropyl α,β-diisopropyleicosanedioate, diisopropyl α,β-diisopropyleicosanedioate, dibutyl α,β-diisopropyleicosanedioate, diisobutyl α,β-diisopropyleicosanedioate, dipentyl α,β-diisopropyleicosanedioate, diisopentyl α,β-diisopropyleicosanedioate, dihexyl α,β-diisopropyleicosanedioate, diisohexyl α,β-diisopropyleicosanedioate, diheptyl α,β-diisopropyleicosanedioate, diisoheptyl α,β-diisopropyleicosanedioate, dioctyl α,β-diisopropyleicosanedioate, diisooctyl α,β-diisopropyleicosanedioate, bis(2-ethylhexyl) α,β-diisopropyleicosanedioate

The solid catalyst component for olefin polymerization constituting the solid catalyst for olefin polymerization of the present invention can be produced by a method of bringing a titanium compound, a magnesium compound, and a compound represented by formula (II) into contact with each other (catalyst component production method-1), or a method of bringing a solid component containing a titanium atom and a magnesium atom, and a compound represented by formula (II) into contact with each other (catalyst component production method 2).

The titanium compound used in the catalyst component production method-1 can include titanium tetrahalides such as titanium tetrachloride, titanium tetrabromide, and titanium tetraiodide; tetraalkoxytitaniums such as tetramethoxytitanium, tetraethoxytitanium, tetra-n-propoxytitanium, tetraisopropoxytitanium, tetra-n-butoxytitanium, tetraisobutoxytitanium, and tetracyclohexyloxytitanium; tetraaryloxytitaniums such as tetraphenoxytitanium; alkoxytitanium trichlorides such as methoxytitanium trichloride, ethoxytitanium trichloride, n-propoxytitanium trichloride, and n-butoxytitanium trichloride; dichlorinated dialkoxytitaniums such as dimethoxytitanium dichloride, diethoxytitanium dichloride, diisopropoxytitanium dichloride, and di-n-propoxytitanium dichloride; monochlorinated trialkoxytitaniums such as trimethoxytitanium chloride, triethoxytitanium chloride, triisopropoxytitanium chloride, tri-n-propoxytitanium chloride, and tri-n-butoxytitanium chloride; and combinations of two or more kinds thereof. Among them, titanium tetrahalides or alkoxytitanium trichlorides are preferable, titanium tetrahalides are more preferable, and titanium tetrachloride is further more preferable.

Examples of the magnesium compound used in the catalyst component production method-1 include a compound represented by the following formula (I) or (ii);

MgR¹⁶ₐX³₂-a (i)

Mg(OR¹⁶)ₐX³₂-a (ii)

wherein a is an integer satisfying 0≦a≦2, R¹⁶ denotes a hydrocarbyl group having 1 to 20 carbon atoms, and when there are more than one R¹⁶ group, the R¹⁶ groups are the same or different; and X³ denotes a halogen atom, and there are more than one X³ groups, the X³ groups are the same or different.

Examples of the R¹⁶ include an alkyl group, an aralkyl group, an aryl group, and an alkenyl group, and these may have a halogen atom, a hydrocarbyloxy group, a nitro group, a sulfonyl group, a silyl group, and the like, as a substituent.

Examples of the alkyl group of R¹⁶ include a linear alkyl group such as a methyl group, an ethyl group, a n-propyl group, a n-butyl group, a n-pentyl group, a n-hexyl group, a n-heptyl group, and a n-octyl group; a branched alkyl group such as an isopropyl group, an isobutyl group, a tert-butyl group, an isopentyl group, a neopentyl group, and a 2-ethylhexyl group; and a cyclic alkyl group such as a cyclopropyl group, a cyclobutyl group, a cyclopentyl group, a cyclohexyl group, a cycloheptyl group, and a cyclooctyl group, and preferable is a linear or branched alkyl group having 1 to 20 carbon atoms.

Examples of the aralkyl group of R¹⁶ include a benzyl group and a phenethyl group, and preferable is an aralkyl group having 7 to 20 carbon atoms.

Examples of the aryl group of R¹⁶ include a phenyl group, a naphthyl group, and a tolyl group, and preferable is an aryl group having 6 to 20 carbon atoms.

Examples of the alkenyl group of R¹⁶ include a linear alkenyl group such as a vinyl group, an allyl group, a 3-butenyl group, and a 5-hexenyl group; a branched alkenyl group such as an isobutenyl group and a 4-methyl-3-pentenyl group; and a cyclic alkenyl group such as a 2-cylcohexenyl group and a 3-cyclohexenyl group, and preferable is a linear or branched alkenyl group having 2 to 20 carbon atoms.

Examples of the halogen atom of X³ include a chlorine atom, a bromine atom, an iodine atom, and a fluorine atom, and preferable is a chlorine atom.

The magnesium compounds represented by formula (I) or (ii) can include dialkylmagnesium compounds such as dimethylmagnesium, diethylmagnesium, diisopropylmagnesium, dibutylmagnesium, dihexylmagnesium, dioctylmagnesium, ethylbutylmagnesium, and butyloctylmagnesium; dialkoxymagnesium compounds such as dimethoxymagnesium, diethoxymagnesium, dipropoxymagnesium, dibutoxymagnesium, and dioctoxymagnesium; alkylmagnesium halide compounds such as methylmagnesium chloride, ethylmagnesium chloride, isopropylmagnesium chloride, isobutylmagnesium chloride, t-butylmagnesium chloride, benzylmagnesium chloride, methylmagnesium bromide, ethylmagnesium bromide, isopropylmagnesium bromide, isobutylmagnesium bromide, t-butylmagnesium bromide, hexylmagnesium bromide, benzylmagnesium bromide, methylmagnesium iodide, ethylmagnesium iodide, isopropylmagnesium iodide, isobutylmagnesium iodide, t-butylmagnesium iodide, and benzylmagnesium iodide; alkoxymagnesium chloride compounds such as methoxymagnesium chloride, ethoxymagnesium chloride, isopropoxymagnesium chloride, butoxymagnesium chloride, hexyloxymagnesium chloride, methoxymagnesium bromide, ethoxymagnesium bromide, isopropoxymagnesium bromide, butoxymagnesium bromide, hexyloxymagnesium bromide, methoxymagnesium iodide, ethoxymagnesium iodide, isopropoxymagnesium iodide, butoxymagnesium iodide, and hexyloxymagnesium iodide; and magnesium halide compounds such as magnesium fluoride, magnesia chloride, magnesium bromide, and magnesium iodide.

The magnesium compound is preferably a halogenated magnesium compound, a dialkoxymagnesium compound, or an alkoxymagnesium halide compound.

The halogenated magnesium compound is preferably magnesium chloride. Magnesium chloride is used in the solid state, or is used in the liquid state where the compound is dissolved in an alcohol such as methanol, ethanol, and 2-ethylhexyl alcohol, or a hydrocarbon solvent such as toluene and hexane, or may be an adduct of an alcohol, an ether, or an ester.

The dialkoxymagnesium compound is preferably dialkoxymagnesium having 1 to 20 carbon atoms, further preferably dialkoxymagnesium having 1 to 10 carbon atoms, and particularly preferably dimethoxymagnesium, diethoxymagnesium, dipropoxymagnesium, diisopropoxymagnesium or dibutoxymagnesium.

Examples of a method of producing the dialkoxymagnesium compound include a method of bringing metal magnesium, and an alcohol such as methanol, ethanol, propanol, butanol, and octanol into contact with each other, in the presence of a catalyst. Examples of the catalyst include a halogen such as iodide, chlorine, and bromine; and halogenated magnesium such as magnesium iodide and magnesium chloride, and preferable is iodine.

The alkoxymagnesium halide compound is preferably hydrocarbyloxymagnesium chloride having 1 to 20 carbon atoms, further preferably hydrocarbyloxymagnesium chloride having 1 to 10 carbon atoms, and particularly preferably methoxymagnesium chloride, ethoxymagnesium chloride, n-propoxymagnesium chloride, isopropoxymagnesium chloride, or butoxymagnesium chloride.

The magnesium compound may be supported by a carrier. A carrier substance is not particularly limited, and examples include a porous inorganic oxide such as SiO₂, Al₂O₃, MgO, TiO₂, and ZrO₂; and an organic porous polymer such as polystyrene, a styrene-divinylbenzene copolymer, a styrene-ethylene glycol-methyl dimethacrylate copolymer, poly(methyl acrylate), poly(ethyl acrylate), a methyl acrylate-divinylbenzene copolymer, poly(methyl methacrylate), a methyl methacrylate-divinylbenzene copolymer, polyacrylonitrile, an acrylonitrile-divinylbenzene copolymer, polyvinyl chloride, polyethylene, and polypropylene. Among them, preferable is a porous inorganic oxide, and particularly preferable is SiO₂.

From the viewpoint that the magnesium compound is effectively immobilized, the carrier is a porous carrier in which a volume of a pore having a pore radius of 20 to 200 nm is preferably 0.3 cm³/g or more and more preferably 0.4 cm³/g or more, and the pore volume is preferably 35% or more and more preferably 40% or more based on a volume of a pore having a pore radius of 3.5 to 7500 nm.

In the catalyst component production method-1, a use amount of the titanium compound is usually 0.1 to 1000 mmol, preferably 0.3 to 500 mmol, and particularly preferably 0.5 to 300 mmol, per mol of the total magnesium atom in the magnesium compound to be used. The titanium compound is used at once, or by dividing into an arbitrary plurality of times.

In the catalyst component production method-1, a use amount of the compound represented by formula (II) is usually 1 to 1000 mmol, preferably 5 to 1000 mmol, and particularly preferably 10 to 500 mmol, per mol of the total magnesium atom in the magnesium compound to be used. The compound represented by formula (II) is used at once, or by dividing into an arbitrary plurality of times.

A contact method in the catalyst component production method-1 is not particularly limited. Examples of the method include the known method such as a slurry method and a mechanical grinding method (e.g., a method with a ball mill).

A slurry concentration in the slurry method is usually 0.05 to 0.7 g solid/ml solvent and particularly preferably 0.1 to 0.5 g solid/ml solvent. A temperature for contact is usually 30 to 150° C., preferably 45 to 135° C., and particularly preferably 60 to 120° C. A contact time is not particularly limited, and is usually preferably around 30 minutes to 6 hours. The “contact time” in the present invention, when the titanium compound, the magnesium compound, the compound represented by formula (I), and the carboxylic halide are simultaneously brought into contact with each other, means a time of the simultaneous contact and, when these compounds are sequentially brought into contact with each other, means the sum of a time of contact at each stage.

The mechanical grinding method is preferably performed in the presence of a liquid substance in order to suppress a content of a fine powder in the resulting solid catalyst component or its extended particle size distribution. Examples of the liquid substance include an aliphatic hydrocarbyl such as pentane, hexane, heptane, and octane; an aromatic hydrocarbyl such as benzene, toluene, and xylene; an alicyclic hydrocarbyl such as cyclohexane and cyclopentane; and a halogenated hydrocarbyl such as 1,2-dichloroethane and monochlorobenzene. Among them, an aromatic hydrocarbyl or a halogenated hydrocarbyl is particularly preferable.

In the catalyst component production method-1, a compound represented by formula (iii) may also be arbitrarily contacted:

M¹R⁴_{m-c}X⁴_{c} (iii)

wherein M¹ represents a group 13 or group 14 atom of the periodic table; R⁴ represents a hydrocarbyl group or a hydrocarbyloxy group having 1 to 20 carbon atoms; X⁴ represents a halogen atom; m represents a valence of M¹, and c represents an integer satisfying 0<c≦m.

Examples of the 13 group element of M¹ include boron, aluminum, gallium, indium, and thallium. Among them, preferable is boron or aluminum, and more preferable is aluminum.

Examples of the 14 group element of M¹ include silicon, germanium, tin, and lead. Among them, preferable is silicon, germanium or tin, and more preferable is silicon.

Examples of the hydrocarbyl group of R⁴ include a linear or branched alkyl group such as a methyl group, an ethyl group, a propyl group, an isopropyl group, a butyl group, an isobutyl group, a pentyl group, an isopentyl group, a hexyl group, a heptyl group, an octyl group, a decyl group, and a dodecyl group; a cyclic alkyl group such as a cyclohexyl group and a cyclopentyl group; and an aryl group such as a phenyl group, a cresyl group, a xylyl group, and a naphthyl group.

Examples of the hydrocarbyloxy group of R⁴ include a linear or branched alkoxy group such as a methoxy group, an ethoxy group, a propoxy group, an isopropoxy group, a butoxy group, an isobutoxy group, an amyloxy group, an isoamyloxy group, a hexyloxy group, a heptyloxy group, an octyloxy group, a decyloxy group, and a dodecyloxy group; a cyclic alkoxy group such as a cyclohexyloxy group and a cyclopentyloxy group; and an aryloxy group such as a phenoxy group, a xyloxy group, and a naphthoxy group. Among them, preferable is an alkyl group or an alkoxy group having 2 to 18 carbon atoms; or an aryl group or an aryloxy group having 6 to 18 carbon atoms.

Examples of X⁴ include a fluorine atom, a chlorine atom, a bromine atom, and an iodine atom, and preferable is a chlorine atom or a bromine atom.

And, m which is a valence of M¹ is 3 when M¹ is the 13 group element, and 4 when M¹ is the 14 group element.

Examples of the compound represented by formula (iii) include a chlorinated aluminum compound and a chlorinated silicon compound. Among them, preferable is ethylaluminum dichloride, ethylaluminum sesquichloride, diethylaluminum chloride, trichloroaluminum, tetrachlorosilane, phenyltrichlorosilane, methyltrichlorosilane, ethyltrichlorosilane, normalpropyltrichlorosilane, or paratolyltrichlorosilane, more preferable is a chlorinated compound of a 14 group element, and particularly preferable is tetrachlorosilane and phenyltrichlorosilane.

A use amount of the compound represented by formula (iii) in the catalyst component production method-1 is usually 0.1 to 1000 mmol, preferably 0.3 to 500 mmol, and particularly preferably 0.5 to 300 mmol, per mol of the total magnesium atom in the magnesium compound, and the compound is used at once, or by dividing into an arbitrary plurality of times.

The solid component comprising the titanium atom and the magnesium atom in the catalyst component production method-2 is not particularly limited, as far as it is a solid component comprising a titanium atom and a magnesium atom.

Examples of the solid component include magnesium titanate, magnesium aluminum titanate described in WO 2004/039747, and a solid catalyst component precursor containing a trivalent titanium atom, a magnesium atom and a hydrocarbyloxy group. Among them, preferable is the solid catalyst component precursor. Hereinafter, “solid catalyst component precursor” is described as “precursor” in some cases.

Examples of the hydrocarbyloxy group of the precursor include a hydrocarbyloxy group having 1 to 20 carbon atoms, and preferable is a methoxy group, an ethoxy group, a n-propoxy group, an isopropoxy group, a n-butoxy group, an isobutoxy group, a pentoxy group, a cyclopentoxy group, or a cyclohexoxy group.

A method of producing the precursor is not particularly limited, and examples thereof include a method of reducing the titanium compound with an organomagnesium compound in the presence of a silicon compound having a Si—O bond. A reduction reaction is preferably performed by adding an organomagnesium compound to a solution containing a silicon compound, a titanium compound and a solvent.

Examples of the silicon compound include a compound represented by any of the following formulas (iv) to (vi):

Si(OR⁵)ₜR⁶₍₄₋ₜ₎ (iv)

R⁷(R⁸₂SiO)ᵤSiR⁹₃ (v)

(R¹⁰₂SiO)ᵥ (vi)

wherein R⁵, R⁶, R⁷, R⁸, R⁹ and R¹⁰ are each independently a hydrocarbyl group having 1 to 20 carbon atoms or a hydrogen atom; t is an integer of 1 to 4; u is an integer of 1 to 1000; and v is an integer of 2 to 1000.

Examples of the hydrocarbyl group of R⁵, R⁶, R⁷, R⁸, R⁹ and R¹⁰ include an alkyl group such as a methyl group, an ethyl group, a n-propyl group, an isopropyl group, a n-butyl group, an isobutyl group, a n-pentyl group, an isopentyl group, a hexyl group, a heptyl group, an octyl group, a decyl group, and a dodecyl group; an aryl group such as a phenyl group, a cresyl group, a xylyl group, and a naphthyl group; a cycloalkyl group such as a cyclohexyl group and a cyclopentyl group; an alkenyl group such as an allyl group; and an aralkyl group such as a benzyl group. Among them, preferable is an alkyl group having 2 to 18 carbon atoms or an aryl group having 6 to 18 carbon atoms, and particularly preferable is a linear alkyl group having 2 to 18 carbon atoms.

Examples of the silicon compound having a Si—O bond represented by any of formulas (iv) to (vi) include tetramethoxysilane, dimethyldimethoxysilane, tetraethoxysilane, triethoxyethylsilane, diethoxydiethylsilane, ethoxytriethylsilane, tetraisopropoxysilane, diisopropoxy-diisopropylsilane, tetrapropoxysilane, dipropoxydipropylsilane, tetrabutoxysilane, dibutoxydibutylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane, and phenylhydropolysiloxane. Among them, preferable is tetraalkoxysilane in which t in formula (iv) is 4, and most preferable is tetraethoxysilane.

Examples of the titanium compound for producing the precursor include a compound represented by the following formula (vii):

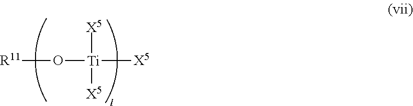

wherein R¹¹ represents a hydrocarbyl group having 1 to 20 carbon atoms; X⁵ represents a halogen atom or a hydrocarbyloxy group having 1 to 20 carbon atoms, and the X⁵ groups are the same or different; and 1 represents an integer of 1 to 20.

Examples of R¹¹ include an alkyl group such as a methyl group, an ethyl group, a n-propyl group, an isopropyl group, a n-butyl group, an isobutyl group, a n-pentyl group, an isopentyl group, a n-hexyl group, a n-heptyl group, a n-octyl group, a n-decyl group, and a n-dodecyl group; an aryl group such as a phenyl group, a cresyl group, a xylyl group, and a naphthyl group; a cycloalkyl group such as a cyclohexyl group and a cyclopentyl group; an alkenyl group such as an allyl group; and an aralkyl group such as a benzyl group. R¹¹ is preferably an alkyl group having 2 to 18 carbon atoms or an aryl group having 6 to 18 carbon atoms, and particularly preferably a linear alkyl group having 2 to 18 carbon atoms.

Examples of the halogen atom of X⁵ include a chlorine atom, a bromine atom, and an iodine atom. Particularly preferable is a chlorine atom.

The hydrocarbyloxy group of X⁵ is preferably an alkoxy group having 2 to 18 carbon atoms, more preferably an alkoxy group having 2 to 10 carbon atoms, and particularly preferably an alkoxy group having 2 to 6 carbon atoms.

Examples of the titanium compound represented by formula (vii) include tetramethoxytitanium, tetraethoxytitanium, tetra-n-propoxytitanium, tetraisopropoxytitanium, tetra-n-butoxytitanium, tetraisobutoxytitanium, n-butoxytitanium trichloride, di-n-butoxytitanium dichloride, tri-n-butoxytitanium chloride, di-n-tetraisopropyl polytitanate (a mixture in a range of 1=2 to 10), tetra-n-butyl polytitanate (a mixture in a range of 1=2 to 10), tetra-n-hexyl polytitanate (a mixture in a range of 1=2 to 10), tetra-n-octyl polytitanate (a mixture in a range of 1=2 to 10), and a condensate of tetraalkoxytitanium obtained by reacting tetraalkoxytitanium with a small amount of water, and a combination of 2 or more of them.

The titanium compound represented by formula (vii) is preferably a titanium compound in which 1 is 1, 2 or 4, and more preferably tetra-n-butoxytitanium, a tetra-n-butoxyltitanium dimer or a tetra-n-butoxyltitanium tetramer.

The organomagnesium compound for producing the precursor is a compound having a bond of magnesium atom-carbon atom. Examples of the organomagnesium compound include a compound represented by the following formula (viii) or (ix) and, from the viewpoint that a precursor having a good form is obtained, a Grignard compound represented by the former formula (viii) is preferable, and an ether solution of the Grignard compound is particularly preferable:

R¹²MgX⁶ (viii)

R¹³R¹⁴Mg (ix)

wherein R¹², R¹³ and R¹⁴ represent a hydrocarbyl group having 1 to 20 carbon atoms; and X⁶ represents a halogen atom.

Examples of the hydrocarbyl group of R¹², R¹³ and R¹⁴ include an alkyl group such as a methyl group, an ethyl group, a n-propyl group, an isopropyl group, a n-butyl group, an isobutyl group, a n-pentyl group, an isopentyl group, a hexyl group, a heptyl group, an octyl group, a decyl group, and a dodecyl group; an aryl group such as a phenyl group, a cresyl group, a xylyl group, and a naphthyl group; a cycloalkyl group such as a cyclohexyl group and a cyclopentyl group; an alkenyl group such as an allyl group; and an aralkyl group such as a benzyl group. Among them, preferable is an alkyl group having 2 to 18 carbon atoms or an aryl group having 6 to 18 carbon atoms, and particularly preferable is a linear alkyl group having 2 to 18 carbon atoms.

Examples of X⁶ include a chlorine atom, a bromine atom, and an iodine atom. Particularly preferable is a chlorine atom.

The Grignard compound represented by the above formula can include methylmagnesium chloride, ethylmagnesium chloride, n-propylmagnesium chloride, isopropylmagnesium chloride, n-butylmagnesium chloride, isobutylmagnesium chloride, tert-butylmagnesium chloride, n-pentylmagnesium chloride, isopentylmagnesium chloride, cyclopentylmagnesium chloride, n-hexylmagnesium chloride, cyclohexylmagnesium chloride, n-octylmagnesium chloride, 2-ethylhexylmagnesium chloride, phenylmagnesium chloride, and benzylmagnesium chloride. Among them, ethylmagnesium chloride, n-propylmagnesium chloride, isopropylmagnesium chloride, n-butylmagnesium chloride, or isobutylmagnesium chloride is preferable, and n-butylmagnesium chloride is particularly preferable.

These Grignard compounds are preferably used as an ether solution of them. Examples of the ether include a dialkyl ether such as diethyl ether, di-n-propyl ether, diisopropyl ether, di-n-butyl ether, diisobutyl ether, ethyl n-butyl ether, and diisopentyl ether, and a cyclic ether such as tetrahydrofuran. Among them, dialkyl ether is preferable, and di-n-butyl ether or diisobutyl ether is particularly preferable.

The reducing reaction for producing the precursor may be performed in the presence of a compound having an ester group.

The compound having an ester group is not particularly limited. Examples of the compound include monovalent or polyvalent carboxylate, and more specifically include saturated aliphatic carboxylate, unsaturated aliphatic carboxylate, alicyclic carboxylate, and aromatic carboxylate. Further specifically, examples include, in addition to the compound of formula (II), methyl acetate, ethyl acetate, phenyl acetate, methyl propionate, ethyl propionate, ethyl butyrate, ethyl valerate, ethyl acrylate, methyl methacrylate, ethyl benzoate, butyl benzoate, methyl toluate, ethyl toluate, ethyl anisate, diisobutyl phthalate, bis(2-ethylhexyl) phthalate, diethyl succinate, dibutyl succinate, diethyl malonate, dibutyl malonate, dimethyl maleate, dibutyl maleate, diethyl itaconate, and dibutyl itaconate. Preferable is saturated aliphatic carboxylate and aromatic carboxylate, and more preferable is a compound described as an example of formula (II), diisobutyl phthalate and bis(2-ethylhexyl) phthalate.

Examples of a solvent used in the reducing reaction include an aliphatic hydrocarbon compound such as hexane, heptane, octane, and decane; an aromatic hydrocarbon compound such as toluene and xylene; an alicyclic hydrocarbon compound such as cyclohexane, methylcyclohexane, and decalin; a dialkyl ether such as diethyl ether, di-n-propyl ether, diisopropyl ether, di-n-butyl ether, diisobutyl ether, ethyl-n-butyl ether, and diisopentyl ether, and a cyclic ether such as tetrahydrofuran; a halogenated aromatic compound such as chlorobenzene and dichlorobenzene; and a combination of 2 or more of them. Among them, preferable is an aliphatic hydrocarbon compound, an aromatic hydrocarbon compound, or an alicyclic hydrocarbon compound, more preferable is an aliphatic hydrocarbon compound or an alicyclic hydrocarbon compound, further preferable is an aliphatic hydrocarbon compound, and particularly preferable is hexane or heptane.

A use amount of the silicon compound in the reducing reaction is such an amount that a silicon atom is usually 1 to 500 mol, preferably 1 to 300 mol, and particularly preferably 3 to 100 mol, per mol of the total titanium atom in the titanium compound to be used.

A use amount of the organomagnesium compound in the reducing reaction is such an amount that a magnesium atom is usually 0.1 to 10 mol, preferably 0.2 to 5.0 mol, and particularly preferably 0.5 to 2.0 mol, per mol of the total atom of the titanium compound and the silicon atom to be used.

Each use amount of the titanium compound, the silicon compound and the organomagnesium compound in the reducing reaction may be determined so that an amount of a magnesium atom in the resulting precursor may be 1 to 51 mol, preferably 2 to 31 mol, and particularly preferably 4 to 26 mol, per mol of a titanium atom in the precursor.

A use amount of the compound having an ester group in the reducing reaction is usually 0.05 to 100 mol, preferably 0.1 to 60 mol, and particularly preferably 0.2 to 30 mol, per mol of the total titanium atom in the titanium compound to be used.

A temperature during which the organomagnesium compound is added to a solution containing a silicon compound, a titanium compound and a solvent is usually in a range of −50 to 100° C., preferably in a range of −30 to 70° C., and particularly preferably in a range of −25 to 50° C. A time during which the organomagnesium compound is added is not particularly limited, and is usually around 30 minutes to 6 hours. From the viewpoint that the precursor in a good form is obtained, it is preferable that the organomagnesium compound is continuously added. The reaction mixture may be heat-treated at 5 to 120° C. after the organomagnesium compound is continuously charged.

The reducing reaction is performed in the presence of a carrier, and the resulting precursor may be supported by the carrier. The carrier is not particularly limited, and examples include a porous inorganic oxide such as SiO₂, Al₂O₃, MgO, TiO₂, and ZrO₂; an organic porous polymer such as polystyrene, a styrene-divinylbenzene copolymer, poly(methyl acrylate), polyethyl acrylate), a methyl acrylate-divinylbenzene copolymer, poly(methyl methacrylate), a methyl methacrylate-divinylbenzene copolymer, polyacrylonitrile, an acrylonitrile-divinylbenzene copolymer, polyvinyl chloride, polyethylene, and polypropylene. Among them, preferable is an organic porous polymer, and particularly preferable is a styrene-divinylbenzene copolymer.

From the viewpoint that the precursor is effectively immobilized, the carrier is a porous carrier in which a volume of a pore having a pore radius of 20 to 200 nm is preferably 0.3 cm³/g or more and more preferably 0.4 cm³/g or more, and the pore volume is preferably 35% or more and more preferably 40% or more based on a volume of a pore having a pore radius of 3.5 to 7500 nm.

In the reducing reaction, a titanium atom of the titanium compound represented by formula (vii) is reduced from tetravalent to trivalent. In the present invention, it is preferable that substantially all tetravalent titanium atoms are reduced to trivalent ones. The resulting precursor contains a trivalent titanium atom, a magnesium atom and a hydrocarbyloxy group, generally has amorphous property or extremely weak crystallizability, and is preferably of an amorphous structure.

The resulting precursor may be washed with a solvent. Examples of the solvent include an aliphatic hydrocarbon such as pentane, hexane, heptane, octane, and decane; an aromatic hydrocarbon such as benzene, toluene, ethylbenzene, and xylene; an alicyclic hydrocarbon such as cyclohexane and cyclopentane; a halogenated hydrocarbon such as 1,2-dichloroethane and monochlorobenzene. Among them, an aliphatic hydrocarbon or an aromatic hydrocarbon is preferable, an aromatic hydrocarbon is more preferable, and toluene or xylene is particularly preferable.

In the catalyst component production method-2, a use amount of the compound represented by formula (II) is usually 0.1 to 1000 mol, preferably 0.3 to 500 mol, and particularly preferably 0.5 to 300 mol, per gram of the solid component. The compound represented by formula (II) is used at once, or by dividing into an arbitrary plurality of times.

In the catalyst component production method-2, a contact temperature is not particularly limited, and is usually in a range of −50 to 200° C., preferably in a range of 0 to 170° C., more preferably in a range of 50 to 150° C., and particularly preferably in a range of 50 to 120° C.

In the catalyst component production method-2, a contact time is not particularly limited, and is usually in a range of 10 minutes to 12 hours, preferably in a range of 30 minutes to 10 hours, and particularly preferably in a range of 1 hour to 8 hours.

In the catalyst component production method-2, a halogenated metal compound represented by the following formula (x) may also be arbitrarily contacted:

M²R¹⁵_{h-d}X⁷_{d} (x)

wherein M² represents a 4 group, 13 group or 14 group atom of the periodic table; R¹⁵ represents a hydrocarbyl group or a hydrocarbyloxy group having 1 to 20 carbon atoms; X⁷ represents a halogen atom: h represents a valence of M²; and d represents a number satisfying 0<d≦h.

Examples of the 4 group element of M² include titanium, zirconium and hafnium. Among them, preferable is titanium. Examples of the 13 group element of M² include boron, aluminum, gallium, indium, and thallium. Among them, preferable is boron or aluminum, and more preferable is aluminum. Examples of the 14 group element of M² include silicon, germanium, tin, and lead. Among them, preferable is silicon, germanium or tin, and more preferable is silicon.

Examples of the hydrocarbyl group of R¹⁵ include a linear or branched alkyl group such as a methyl group, an ethyl group, a n-propyl group, an isopropyl group, a n-butyl group, an isobutyl group, a n-pentyl group, an isopentyl group, a n-hexyl group, a n-heptyl group, a n-octyl group, a n-decyl group, and a n-dodecyl group; a cyclic alkyl group such as a cyclohexyl group, and a cyclopentyl group, and an aryl group such as a phenyl group, a cresyl group, a xylyl group, and a naphthyl group.

Examples of the hydrocarbyloxy group of R¹⁵ include a linear or branched alkoxy group such as a methoxy group, an ethoxy group, a n-propoxy group, an isopropoxy group, a butoxy group, an isobutoxy group, an amyloxy group, an isoamyloxy group, a hexyloxy group, a heptyloxy group, an octyloxy group, a decyloxy group, and dodecyloxy group; a cyclic alkoxy group such as a cyclohexyloxy group and a cyclopentyloxy group; and an aryloxy group such as a phenoxy group, a xyloxy group, and a naphthoxy group. Among them, preferable is an alkyl group or an alkoxy group having 2 to 18 carbon atoms; or an aryl group or an aryloxy group having 6 to 18 carbon atoms.

Examples of the X⁷ include a fluorine atom, a chlorine atom, a bromine atom or an iodine atom, and preferable is a chlorine atom or a bromine atom.

And, the h is 4 when M² is the 4 group element, is 3 when M² is the 13 group element, and is 4 when M² is the 14 group element.

The d represents an integer satisfying 0<d≦4 when M² is the 4 group element or the 14 group element, and represents an integer satisfying 0<d≦3 when M² is the 13 group element. Preferable d when M² is the 4 group element or the 14 group element is 3 or 4, and more preferably 4. Preferable d when M² is the 13 group element is 3.

Examples of the halogenated metal compound represented by formula (x) include a chlorinated compound described in U.S. Pat. No. 6,187,883, and the chlorinated compound of a 13 group element and a chlorinated compound of a 14 group element described in U.S. Pat. No. 6,903,041.

The halogenated titanium compound which is the halogenated metal compound represented by formula (x) is preferably a tetrahalogenated titanium compound such as titanium tetrachloride, titanium tetrabromide, and titanium tetraiodide; or a trihalogenated alkoxytitanium compound such as methoxytitanium trichloride, ethoxytitanium trichloride, butoxytitanium trichloride, phenoxytitanium trichloride, and ethoxytitanium tribromide, more preferably a tetrahalogenated titanium compound, and particularly preferably titanium tetrachloride.

The chlorinated compound of a 13 group element or a chlorinated compound of a 14 group element which is the halogenated metal compound represented by formula (x) is preferably ethylaluminum dichloride, ethylaluminum sesquichloride, diethylaluminum chloride, trichloroaluminum, tetrachlorosilane, phenyltrichlorosilane, methyltrichlorosilane, ethyltrichlorosilane, normalpropyltrichlorosilane, or paratolyltrichlorosilane, more preferably a chlorinated compound of a 14 group element, and particularly preferably tetrachlorosilane and phenyltrichlorosilane.

A use amount of the halogenated metal compound represented by formula (x) is usually 0.1 to 1000 mmol, preferably 0.3 to 500 mmol, and particularly preferably 0.5 to 300 mmol, per gram of the precursor. The halogenated metal compound is used at once, or by dividing into an arbitrary plurality of times.

A contact method in the catalyst production method-2 is not particularly limited. Examples of the method include the known method such as a slurry method and a mechanical grinding method (e.g., a method with a ball mill). The mechanical grinding method is preferably performed in the presence of the diluent in order to suppress a content of a fine powder in the resulting solid catalyst component, or its extended particle size distribution.

A slurry concentration in the slurry method is usually 0.05 to 0.7 g solid/ml solvent, and particularly preferably 0.1 to 0.5 g solid/ml solvent. A temperature for contact is usually 30 to 150° C., preferably 45 to 135° C., and particularly preferably 60 to 120° C. A time for contact is not particularly limited, and is usually preferably around 30 minutes to 6 hours.

A method of bringing the solid catalyst component for olefin polymerization, the organoaluminum compound, and the compound represented by formula (I) into contact with each other is not particularly limited, as far as the solid catalyst for olefin polymerization is produced. Contact is performed in the presence or absence of a solvent. A mixture obtained by bringing them into contact with each other may be supplied to a polymerization tank, or these may be separately supplied to a polymerization tank and brought into contact with each other in the polymerization tank, or a mixture obtained by bringing arbitrary two components into contact with each other and a remaining component may be separately supplied to a polymerization tank.

Examples of an olefin used in the process for producing an olefin polymer of the present invention include ethylene, and an α-olefin having 3 or more carbon atoms. Examples of the α-olefin include a linear α-olefin such as propylene, 1-butene, 1-pentene, 1-hexene, 1-heptene, 1-octene, and 1-decene; a branched α-olefin such as 3-methyl-1-butene, 3-methyhl-1-pentene, and 4-methyl-1-pentene, and a combination of two or more of them. Among them, preferably, ethylene or propylene is homopolymerized, or ethylene or propylene and other α-olefin are copolymerized using ethylene or propylene as a main component, and more preferably, ethylene and an α-olefin are copolymerized so that a content of a constituent unit derived from ethylene may be 50 wt % or more when it is assumed that the total amount of the resulting copolymer is 100 wt %.

When ethylene or propylene and other α-olefin are copolymerized, other α-olefin may be two or more kinds of α-olefins. Ethylene and a compound selected from α-olefins having 3 or more carbon atoms, a compound having a polyunsaturated bond such as a conjugated diene and a non-conjugated diene, and a compound having a cyclic unsaturated bond such as vinylcyclohexane may be copolymerized.

Examples of the olefin polymer produced by the process for producing an olefin polymer of the present invention preferably include an ethylene homopolymer; an α-olefin homopolymer such as a propylene homopolymer, a 1-butene homopolymer, a 1-pentene homopolymer, and a 1-hexene homopolymer; an ethylene-α-olefin copolymer such as an ethylene-propylene copolymer, an ethylene-1-butene copolymer, and an ethylene-1-hexene copolymer; an α-olefin-α-olefin copolymer such as a propylene-1-butene copolymer and a propylene-1-hexene copolymer; a terpolymer such as an ethylene-propylene-1-butene copolymer and an ethylene-propylene-1-hexene copolymer; and a polymer obtained by, after homopolymerization of an olefin, copolymerizing two or more olefins in the presence of the produced homopolymer.

A temperature for polymerization is usually −30 to 300° C., and preferably 20 to 180° C. A polymerization pressure is not particularly limited, and is generally an ambient pressure to 10 MPa, and preferably around 200 kPa to 5 MPa from the viewpoint of being industrial and economical. Polymerization is in a batch mode or a continuous mode, and examples of a polymerization method include a slurry polymerization method or a solution polymerization method using, as a solvent, an inert hydrocarbon such as propane, butane, isobutane, pentane, hexane, heptane, and octane, a bulk polymerization method using, as a medium, an olefin which is liquid at a polymerization temperature, and a vapor-phase polymerization method.

As a method for forming the solid catalyst for polymerization of the present invention, in addition to a method of bringing a solid catalyst component for olefin polymerization, an organoaluminum compound, and a compound represented by formula (I) into contact with each other, a method comprising the following steps (1) and (2) is more preferable, in some cases:

(1) a step of polymerizing a small amount of an olefin (which is the same as or different from an olefin used in the original polymerization (usually, called main polymerization) (in order to regulate a molecular weight of an olefin polymer to be produced, a chain transfer agent such as hydrogen may be used, or a compound represented by formula (I) (hereinafter, referred to as external electron donor, in some cases) may be used) in the presence of a solid catalyst component and an organoaluminum compound, to produce a catalyst component, a surface of which is covered with a polymer of the olefin (the polymerization is usually called prepolymerization and, therefore, the catalyst component is usually called prepolymerization catalyst component), and

(2) a step of bringing the prepolymerization catalyst component, the organoaluminum compound, and the external electron donor into contact with each other.

The term “solid catalyst component” in the present invention means not only the aforementioned “solid catalyst component”, but also the “prepolymerization catalyst component” or “a combination of both of them”. Prepolymerization is preferably slurry polymerization using, as a solvent, an inert hydrocarbon such as propane, butane, isobutane, pentane, isopentane, hexane, heptane, octane, cyclohexane, benzene, and toluene.

A use amount of the organoaluminum compound used in step (1) is usually 0.5 to 700 mol, preferably 0.8 to 500 mol, and particularly preferably 1 to 200 mol, per mol of a titanium atom in the solid catalyst component used in step (1).

An amount of the olefin to be prepolymerized is usually 0.01 to 1000 g, preferably 0.05 to 500 g, and particularly preferably 0.1 to 200 g per gram of the solid catalyst component used in step (1).

A slurry concentration of the solid catalyst component when step (1) is performed by slurry polymerization is preferably 1 to 500 g-solid catalyst component/liter-solvent, and particularly preferably 3 to 300 g-solid catalyst component/liter-solvent.

A temperature for prepolymerization is preferably −20 to 100° C., and particularly preferably 0 to 80° C. A partial pressure of the olefin at a vapor portion in prepolymerization is preferably 0.01 to 2 MPa and particularly preferably 0.1 to 1 MPa, and this does not apply to the olefin which is liquid at a pressure or a temperature for prepolymerization. A time for prepolymerization is not particularly limited, and is preferably 2 minutes to 15 hours.

Examples of a method of supplying the solid catalyst component, the organoaluminum compound, and the olefin in prepolymerization to a polymerization tank include the following methods (1) and (2):

(1) a method of supplying the solid catalyst component and the organoaluminum compound and, thereafter, supplying the olefin; and
(2) a method of supplying the solid catalyst component and the olefin and, thereafter, supplying the organoaluminum compound.

Examples of a method of supplying the olefin in prepolymerization to a polymerization tank include the following methods (1) and (2):

(1) a method of sequentially supplying the olefin so that a pressure in the polymerization tank may be maintained at a prescribed pressure; and
(2) a method of supplying the total predetermined amount of the olefin at once.

A use amount of the external electron donor used in prepolymerization is usually 0.01 to 400 mol, preferably 0.02 to 200 mol, and particularly preferably 0.03 to 100 mol, based on 1 mol of a titanium atom contained in the solid catalyst component, and is usually 0.003 to 5 mol, preferably 0.005 to 3 mol, and particularly preferably 0.01 to 2 mol, based on 1 mol of the organoaluminum compound.

Examples of a method of supplying the external electron donor in prepolymerization to a polymerization tank include the following methods (1) and (2):

(1) a method of supplying the external electron donor alone; and
(2) a method of supplying a product obtained by bringing the external electron donor and the organoaluminum compound into contact with each other.
The prepolymerization is also described in JP-A-11-322833.

A use amount of the organoaluminum compound at main polymerization is usually 1 to 1000 mol and particularly preferably 5 to 600 mol per mol of a titanium atom in the solid catalyst component.

A use amount of the external electron donor at main polymerization is usually 0.1 to 2000 mol, preferably 0.3 to 1000 mol, and particularly preferably 0.5 to 800 mol, per mol of a titanium atom contained in the solid catalyst component, and is usually 0.001 to 5 mol, preferably 0.005 to 3 mol, and particularly preferably 0.01 to 1 mol, per mol of the organoaluminum compound.

A temperature for main polymerization is usually −30 to 300° C. and preferably 20 to 180° C. A polymerization pressure is not particularly limited, and is generally an ambient pressure to 10 MPa and preferably around 200 kPa to 5 MPa from the viewpoint of being industrial and economical. Polymerization is in a batch mode or a continuous mode, and examples of a polymerization method include a slurry polymerization method or a solution polymerization method using, as a solvent, an inert hydrocarbon such as propane, butane, isobutane, pentane, hexane, heptane, and octane, a bulk polymerization method using, as a medium, an olefin which is liquid at a polymerization temperature, and a vapor-phase polymerization method.

In order to regulate a molecular weight of a polymer obtained in main polymerization, a chain transfer agent (e.g., hydrogen, and alkylzinc such as dimethylzinc and diethylzinc) may be used.

### EXAMPLES

Hereinafter, the present invention will be described in more detail by way of Examples, and the present invention is not particularly limited by the following Examples.

(1) A content of a titanium atom in a solid catalyst component for olefin polymerization was determined by degrading about 20 mg of a solid sample with about 30 ml of 2N dilute sulfuric acid, adding thereto 3 ml of 3 wt % aqueous hydrogen peroxide, which is excessive, measuring characteristic absorption at 410 nm of the resulting liquid sample using a double-beam spectrophotometer Model U-2001 manufactured by Hitachi, Ltd., and using a calibration curve which had been separately produced.
(2) A content of the compound (I) was determined by dissolving about 300 mg of the solid catalyst component in 100 ml of N,N-dimethylacetamide, and using a gas chromatographic internal standard method.
(3) A short chain branch number (hereinafter, abbreviated as SCB) was determined by using an infrared spectrophotometer (FT/IR-470PLUS manufactured by JASCO Corporation) to determine a calibration curve from characteristic absorptions of ethylene and 1-butene, and calculating SCB as the number of methyl groups per 1000 carbon atoms.
(4) A flow rate (FR) was determined by measurement at 190° C. in accordance with ASTM D1238. As a measure of melt fluidity, a flow rate ratio (FRR) was adopted. FRR was expressed by a ratio of a flow rate at which a load of 21.60 kg was applied and a flow rate at which a load of 2.160 kg was applied in the flow rate (FR) measuring method, namely, FRR=(flow rate at load of 21.60 kg)÷(flow rate at load of 2.160 kg).
(5) A content of a xylene soluble component at 20° C. (hereinafter, abbreviated as CXS) was measured as follows: 1 g of a polymer was dissolved in 200 ml of boiling xylene, the solution was gradually cooled to 50° C. and, then, cooled to 20° C. with stirring and allowed to stand at 20° C. for 3 hours, and a precipitated polymer was filtered off. A weight percentage of a polymer remaining in the filtrate was adopted as CXS (unit=wt %).

### Example 1

### (1) Synthesis of Solid Catalyst Component Precursor

Into a reactor, equipped with a stirrer, replaced with nitrogen were charged 270 ml of hexane, 79.9 ml of tetraethoxysilane, and 8.1 ml of tetrabutoxytitanium, followed by stirring. Then, to the stirred mixture was added 182 ml of a dibutyl ether solution of butylmagnesium chloride (concentration 2.1 mol/l) dropwise over 4 hours while a temperature of the reactor was retained at 5° C. After the completion of the dropwise addition, the resultant was stirred at 20° C. for 1 hour and then filtered, washing of the resulting solid with 280 ml of toluene was repeated three times, and 136 ml of toluene was added to form a slurry. A content of a titanium atom in the resulting solid catalyst component precursor was 2.09 wt %.

### (2) Synthesis of Solid Catalyst Component

After a 500 ml flask equipped with a stirrer, an addition funnel and a thermometer was replaced with nitrogen, 40 g of the solid catalyst component precursor obtained in (1) was charged thereinto, and toluene was charged thereinto so that the total volume might be 232 ml. Then, 29 ml of silicon tetrachloride and 42 ml of bis(2-ethylhexyl) dodecanedioate were charged thereinto, and the mixture was heated and stirred at 105° C. for 1 hour. The reaction product was subjected to solid-liquid separation, washing of the resulting solid with 200 g of toluene at 105° C. was repeated three times, and thereafter 75 g of toluene was added. Subsequently, 20 ml of titanium tetrachloride was charged thereinto, the mixture was heated and stirred at 105° C. for 2 hours, and the reaction product was subjected to solid-liquid separation. Washing of the resulting solid with 200 g of toluene at 105° C. was repeated six times, thereafter, washing with 175 g of hexane was further repeated three times at room temperature, and the solid after washing was dried to obtain a solid catalyst component. The resulting solid catalyst component for olefin polymerization contained 1.41 wt % of a titanium atom and 24.3 wt % of bis(2-ethylhexyl) dodecanedioate.

### (3) Polymerization of Ethylene and 1-Butene

An autoclave, equipped with a stirrer, having an internal volume of 3 L was sufficiently dried and then vacuated, 0.087 MPa of hydrogen was added, 640 g of butane and 110 g of 1-butene were loaded, and a temperature was raised to 70° C. Then, ethylene was added so that a partial pressure thereof might be 0.6 MPa. Triethylaluminum (5.7 mmol), 0.57 mmol of 2,2-dimethyl-1,3-dioxolane, and 18.4 mg of the solid catalyst component obtained in (2) were pressed into the autoclave with argon, and polymerization was initiated. Thereafter, polymerization was performed at 70° C. for 2 hours while ethylene was continuously supplied and the total pressure was retained at constant. After the completion of the polymerization reaction, an unreacted monomer was purged to obtain 42 g of a polymer having a good powder nature. Little polymer was adhered to an internal wall of the autoclave and the stirrer. A production amount of the polymer per catalyst unit amount (polymerization activity) was 2300 g polymer/g solid catalyst component. As regards this polymer, SCB was 11.8, FR was 0.44, FRR was 28.9, and CXS was 2.6 wt %.

### Example 2

### (1) Polymerization

According to the same manner as that of Example 1 (3) except that 2,2-dimethyl-1,3-dioxolane was changed to 0.57 mmol of 2-methyl-2-ethyl-1,3-dioxolane and an amount of the solid catalyst component was changed to 14.4 mg in Example 1 (3), polymerization was performed to obtain 30 g of a polymer having a good powder nature. Little polymer was adhered to an internal wall of the autoclave and the stirrer. A production amount of the polymer per catalyst unit amount (polymerization activity) was 2100 g polymer/g solid catalyst component. As regards this polymer, SCB was 12.8, FR was 0.62, FRR was 25.8, and CXS was 3.3 wt %.

### Example 3

### (1) Polymerization

According to the same manner as that of Example 1 (3) except that 2,2-dimethyl-1,3-dioxolane was changed to 0.57 mmol of 2,2-diisopropyl-1,3-dioxolane and an amount of the solid catalyst component was changed to 14.7 mg in Example 1 (3), polymerization was performed to obtain 31 g of a polymer having a good powder nature. Little polymer was adhered to an internal wall of the autoclave and the stirrer. A production amount of the polymer per catalyst unit amount (polymerization activity) was 2100 g polymer/g solid catalyst component. As regards this polymer, SCB was 12.6, FR was 0.74, FRR was 28.1, and CXS was 3.4 wt %.

### Example 4

### (1) Polymerization

According to the same manner as that of Example 1 (3) except that 2,2-dimethyl-1,3-dioxolane was changed to 0.57 mmol of 1,1-dimethoxycyclohexane and an amount of the solid catalyst component was changed to 17.4 mg in Example 1 (3), polymerization was performed to obtain 21 g of a polymer having a good powder nature. Little polymer was adhered to an internal wall of the autoclave and the stirrer. A production amount of the polymer per catalyst unit amount (polymerization activity) was 1200 g polymer/g solid catalyst component. As regards this polymer, SCB was 12.2, FR was 0.31, FRR was 27.4, and CXS was 3.0 wt %.

### Example 5

### (1) Polymerization

According to the same manner as that of Example 1 (3) except that 2,2-dimethyl-1,3-dioxolane was changed to 0.57 mmol of 3,3-dimethoxy-1-cyclohexene and an amount of the solid catalyst component was changed to 18.6 mg in Example 1 (3), polymerization was performed to obtain 21 g of a polymer having a good powder nature. Little polymer was adhered to an internal wall of the autoclave and the stirrer. A production amount of the polymer per catalyst unit amount (polymerization activity) was 1000 g polymer/g solid catalyst component. As regards this polymer, SCB was 10.9, FR was 0.21, FRR was 23.6, and CXS was 1.9 wt %.

### Example 6

### (1) Polymerization

According to the same manner as that of Example 1 (3) except that 2,2-dimethyl-1,3-dioxolane was changed to 0.57 mmol of 1,1-dimethoxycyclopentane and an amount of the solid catalyst component was changed to 14.9 mg in Example 1 (3), polymerization was performed to obtain 32 g of a polymer having a good power nature. Little polymer was adhered to an internal wall of the autoclave and the stirrer. A production amount of the polymer per catalyst unit amount (polymerization activity) was 2100 g polymer/g solid catalyst component. As regards this polymer, SCB was 11.2, FR was 0.19, FRR was 30.0, and CXS was 2.0 wt %.

### Example 7

### (1) Polymerization

According to the same manner as that of Example 1 (3) except that 2,2-dimethyl-1,3-dioxolane was changed to 0.57 mmol of 1,1-dimethoxydodecane and an amount of the solid catalyst component was changed to 17.4 mg in Example 1 (3), polymerization was performed to obtain 86 g of a polymer having a good powder nature. Little polymer was adhered to an internal wall of the autoclave and the stirrer. A production amount of the polymer per catalyst unit amount (polymerization activity) was 4900 g polymer/g solid catalyst component. As regards this polymer, SCB was 13.7, FR was 1.55, FRR was 26.8, and CXS was 3.6 wt %.

### Example 8

### (1) Polymerization

According to the same manner as that of Example 1 (3) except that 2,2-dimethyl-1,3-dioxolane was changed to 0.57 mmol of 2-benzyl-1,3-dioxolane and an amount of the solid catalyst component was changed to 14.9 mg in Example 1 (3), polymerization was performed to obtain 35 g of a polymer having a good powder nature. Little polymer was adhered to an internal wall of the autoclave and the stirrer. A polymerization amount of the polymer per catalyst unit amount (polymerization activity) was 2300 g polymer/g solid catalyst component. As regards this polymer, SCB was 10.9, FR was 0.41, FRR was 27.5, and CXS was 2.3 wt %.

### Example 9

### (1) Polymerization

According to the same manner as that of Example 1 (3) except that 2,2-dimethyl-1,3-dioxolane was changed to 0.57 mmol of 1,1-dimethoxyoctane and an amount of the solid catalyst component was changed to 18.3 mg in Example 1 (3), polymerization was performed to obtain 103 g of a polymer having a good powder nature. Little polymer was adhered to an internal wall of the autoclave and the stirrer. A production amount of the polymer per catalyst unit amount (polymerization activity) was 5600 g polymer/g solid catalyst component. As regards this polymer, SCB was 12.7, FR was 1.03, FRR was 27.3, and CXS was 4.1 wt %.

### Example 10

### (1) Polymerization

According to the same manner as that of Example 1 (3) except that 2,2-dimethyl-1,3-dioxolane was changed to 0.57 mmol of 1,3-dioxolane and an amount of the solid catalyst component was changed to 20.5 mg in Example 1 (3), polymerization was performed to obtain 40 g of a polymer having a good powder nature. Little polymer was adhered to an internal wall of the autoclave and the stirrer. A production amount of the polymer per catalyst unit amount (polymerization activity) was 2000 g polymer/g solid catalyst component. As regards this polymer, SCB was 12.0, FR was 0.54, FRR was 26.9, and CXS was 2.8 wt %.

### Example 11

### (1) Polymerization

According to the same manner as that of Example 1 (3) except that 2,2-dimethyl-1,3-dioxolane was changed to 0.57 mmol of 1,1-diethoxycyclohexane and an amount of the solid catalyst component was changed to 20.2 mg in Example 1 (3), polymerization was performed to obtain 23 g of a polymer having a good powder nature. Little polymer was adhered to an internal wall of the autoclave and the stirrer. A production amount of the polymer per catalyst unit amount (polymerization activity) was 1100 g polymer/g solid catalyst component. As regards this polymer, SCB was 10.4, FR was 0.21, FRR was 28.3, and CXS was 2.0 wt %.

### Example 12

### (1) Polymerization

According to the same manner as that of Example 1 (3) except that 2,2-dimethyl-1,3-dioxolane was changed to 0.57 mmol of 3-(dimethoxymethyl)heptane and an amount of the solid catalyst component was changed to 19.2 mg in Example 1 (3), polymerization was performed to obtain 95 g of a polymer having a good powder nature. Little polymer was adhered to an internal wall of the autoclave and the stirrer. A production amount of the polymer per catalyst unit amount (polymerization activity) was 4900 g polymer/g solid catalyst component. As regards this polymer, SCB was 10.9, FR was 0.71, FRR was 25.4, and CXS was 2.1 wt %.

### Comparative Example 1

### (1) Polymerization

According to the same manner as that of Example 1 (3) except that 2,2-dimethyl-1,3-dioxolane was not used and an amount of the solid catalyst component was changed to 13.4 mg in Example 1 (3), polymerization was performed to obtain 128 g of a polymer having a good powder nature. Little polymer was adhered to an internal wall of the autoclave and the stirrer. A production amount of the polymer per catalyst unit amount (polymerization activity) was 9600 g polymer/g solid catalyst component. As regards this polymer, SCB was 14.0, FR was 1.37, FRR was 27.7, and CXS was 5.1 wt %.

### Comparative Example 2

### (1) Polymerization

According to the same manner as that of Example 1 (3) except that 2,2-dimethyl-1,3-dioxolane was not used, an amount of the solid catalyst component was changed to 15.6 mg, an amount of butane was changed to 630 g, and an amount of 1-butene was changed to 120 g in Example 1 (3), polymerization was performed to obtain 119 g of a polymer having a good powder nature. Little polymer was adhered to an internal wall of the autoclave and the stirrer. A production amount of the polymer per catalyst unit amount (polymerization activity) was 7600 g polymer/g solid catalyst component. As regards this polymer, SCB was 15.4, FR was 1.40, FRR was 26.6, and CXS was 6.4 wt %.

### Comparative Example 3

### (1) Polymerization

According to the same manner as that of Example 1 (3) except that 2,2-dimethyl-1,3-dioxolane was not used, an amount of the solid catalyst component was changed to 15.5 mg, an amount of butane was changed to 650 g, and an amount of 1-butene was changed to 100 g in Example 1 (3), polymerization was performed to obtain 110 g of a polymer having a good powder nature. Little polymer was adhered to an internal wall of the autoclave and the stirrer. A production amount of the polymer per catalyst unit amount (polymerization activity) was 7100 g polymer/g solid catalyst component. As regards this polymer, SCB was 12.5, FR was 1.15, FRR was 25.9, and CXS was 4.1 wt %.

1. A solid catalyst for olefin polymerization obtained by bringing a solid catalyst component for olefin polymerization containing a titanium atom, a magnesium atom, a halogen atom, and an aliphatic carboxylate, an organoaluminum compound, and a compound represented by formula (I) into contact with each other: 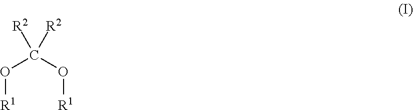
wherein R¹ is a hydrocarbyl group having 1 to 10 carbon atoms, the R¹ groups are the same or different and the R¹ groups may be joined with each other to form a ring; and R² is a hydrogen atom, a halogen atom or a hydrocarbyl group having 1 to 16 carbon atoms, the R² groups are the same or different and the R² groups may be joined with each other to form a ring.

2. The solid catalyst for olefin polymerization according to claim 1, wherein the aliphatic carboxylate is a compound represented by formula (II): 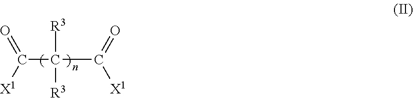
wherein n is an integer satisfying 10≦n≦20; R³ is a hydrogen atom, a halogen atom, or a hydrocarbyl group having 1 to 10 carbon atoms and R³ groups are the same or different; and X¹ is a hydrocarbyloxy group having 1 to 10 carbon atoms and the X¹ groups are same or different.

3. A process for producing an olefin polymer, the process comprising a step of polymerizing an olefin in the presence of the solid catalyst for olefin polymerization according to claim 1.

4. The process according to claim 3, wherein the olefin comprises ethylene and an α-olefin.

5. A process for producing an olefin polymer, the process comprising a step of polymerizing an olefin in the presence of the solid catalyst for olefin polymerization according to claim 2.

6. The process according to claim 5, wherein the olefin comprises ethylene and an α-olefin.
